(19) United States
(12) Patent Application Publication
(10) Pub. No.: US 2025/0076669 A1
(43) Pub. Date: Mar. 6, 2025

(54) POLARIZATION BEAM SPLITTER AND COMBINER WITH ISOLATOR

(71) Applicant: SHENZHEN INNOWAVE TECHNOLOGY CO., LTD., SHENZHEN (CN)

(72) Inventor: GUOQIANG CHEN, SHENZHEN (CN)

(21) Appl. No.: 18/814,609

(22) Filed: Aug. 26, 2024

(30) Foreign Application Priority Data
Sep. 4, 2023 (CN) 202311138878.7

(51) Int. Cl. G02B 27/28; G02B 6/10

(52) U.S. Cl. CPC G02B 27/283; G02B 6/105

(57) ABSTRACT

Present disclosure relates to the field of optical technology and discloses a polarization beam splitter and a polarization beam combiner with isolation functions. The splitter comprises: a single-core waveguide, a lens, a first birefringent crystal, a first Faraday rotator, a second birefringent crystal and a dual-core polarization-maintaining waveguide along the forward optical path successively. The first birefringent crystal, the first Faraday rotator and the second birefringent crystal are all parallel plate structures. By the aforementioned means, the application simplifies the device structure and reduces the device cost.

### CROSS-REFERENCE TO RELATED APPLICATIONS

This application is based upon and claims priority to Chinese Patent Application No. 202311138878.7, filed with the Chinese Patent Office on Sep. 4, 2023, titled “POLARIZATION BEAM SPLITTER AND COMBINER WITH ISOLATOR”, the entire contents of which are incorporated herein by reference.

### TECHNICAL FIELD

Embodiments of the present disclosure relate to the technical field of optics, and, relate to a polarization beam splitter and combiner with an isolation function.

### BACKGROUND

In the design of optical products, it is often necessary to split a beam into two linearly polarized lights which polarization states are perpendicular to each other, or to merge two linearly polarized lights into one optical waveguide. Products that achieve this function are known as polarization beam splitter or combiner. In some scenarios, it is necessary to prevent the backward light from returning to the incident optical path while achieving beam splitting or combining, to avoid affecting the normal operation of the optical devices at the incident surface or even damaging the devices. Therefore, there is a need to incorporate a function for isolating the backward light in the optical path.

In response to this, early solutions involved directly connecting a polarization beam splitter/combiner and an isolator in series within the optical path to achieve simultaneous beam splitting/combining and isolation of backward light. Later, in order to achieve a more compact size and lower cost, designers integrated the polarization beam splitter/combiner core and the isolator core into the collimated optical path of a single device to form a hybrid device with both polarization beam splitting/combining and optical isolation functions.

For hybrid devices that implement polarization beam splitting and optical isolation functions, a collimating lens is configured to convert the beam into collimating beam firstly. The isolator core allows the forward collimating o-light beam and e-light beam to exit in parallel with the input beam, while causing the backward collimating o-light beam and e-light beam to exit the isolator core at an angle to the forward beam which results in the effect of backward light isolation. The polarization beam splitter core splits the forward collimating beam into o-light and e-light, and the output beam forms two collimating beams at a certain angle to the input collimating beam and with a opposite deflection direction. These two collimating beams are then converged by a convergent lens and exported by the two cores of the dual-core polarization-maintaining waveguide to achieve the function of polarization beam splitting and optical isolation. When two linearly polarized lights are imported from the backward direction of the dual-core polarization-maintaining waveguide, they are merged into a backward collimating beam after passing through the polarization beam splitter core, then enter the optical isolator core. The o-light and e-light in the backward collimating beam exit the isolator core at a certain angle to the forward collimating beam, and thus cannot be coupled into the single-core waveguide after passing through the first collimating lens, achieving the function of the isolation to the backward light.

By reversing the input and output ends of the isolator core in the hybrid device that implements the polarization beam splitting and optical isolation functions, a hybrid device with polarization beam combining and optical isolation functions can be formed.

The inventors of the present disclosure have found in practice that: the existing polarization beam splitters/combiners with isolation functions have complex structures and are costly.

### SUMMARY

According to one aspect of the embodiments of present disclosure, a polarization beam splitter with isolation function is provided. The polarization beam splitter with isolation function includes: a single-core waveguide, a lens, a first birefringent crystal, a first Faraday rotator, a second birefringent crystal, and a dual-core polarization-maintaining waveguide that are successively arranged along the forward light path. The first birefringent crystal, the first Faraday rotator, and the second birefringent crystal are all parallel plate structures. The single-core waveguide is configured to import divergent beam and output it to the lens; the lens is configured to convert the divergent beam into convergent beam and output it to the first birefringent crystal; the first birefringent crystal is configured to separate the convergent beam into first crystal forward o-light and first crystal forward e-light that polarization states are perpendicular to each other and form a first forward relative displacement between the first crystal forward o-light and the first crystal forward e-light, and then output them to the first Faraday rotator; the first Faraday rotator is configured to rotate the polarization states of the first crystal forward o-light and the first crystal forward e-light by an angle α in the first rotation direction and then outputting them to the second birefringent crystal, where α=45°; the second birefringent crystal is configured to form a second forward relative displacement between the first crystal forward o-light and the first crystal forward e-light, and then output them to the two cores of the dual-core polarization-maintaining waveguide; the distance between the two cores of the dual-core polarization-maintaining waveguide is equal to the sum of the first forward relative displacement and the second forward relative displacement between the first crystal forward o-light and the first crystal forward e-light, and the polarization states of the two cores of the dual-core polarization-maintaining waveguide are aligned with the polarization states of the first crystal forward o-light and the first crystal forward e-light output from the second birefringent crystal, and the dual-core polarization-maintaining waveguide is configured to export the first crystal forward o-light and the first crystal forward e-light. When two backward linearly polarized lights that are aligned with the polarization states of the two cores of the dual-core polarization-maintaining waveguide respectively enter the two cores of the dual-core polarization-maintaining waveguide along the backward light path, the two cores of the dual-core polarization-maintaining waveguide are configured to output the two backward linearly polarized lights to the second birefringent crystal, and the polarization states of the two backward linearly polarized lights are aligned with the o-light and e-light polarization states of the second birefringent crystal; the second birefringent crystal is configured to form a second backward relative displacement between the two backward linearly polarized lights and then output them to the first Faraday rotator; the first Faraday rotator is configured to rotate the polarization states of the two backward linearly polarized lights by an angle α in the first rotation direction and then output them to the first birefringent crystal; the first birefringent crystal is configured to form a first backward relative displacement between the two backward linearly polarized lights. In the optical path between the forward input surface of the first birefringent crystal and the forward output surface of the second birefringent crystal, the polarization states of the two backward linearly polarized lights form a 90° rotation relative to the forward light with the o-light and e-light undergoing conversion in the first birefringent crystal, causing the optical path of the two backward linearly polarized lights in the first birefringent crystal to deviate from the forward light path in the first birefringent crystal, and ultimately, the two backward linearly polarized lights output from the first birefringent crystal cannot be coupled into the single-core waveguide after passing through the lens.

According to another aspect of the embodiments of the present disclosure, a polarization beam combiner with isolation function is provided, the polarization beam combiner with isolation function includes: a dual-core polarization-maintaining waveguide, a first birefringent crystal, a first Faraday rotator, a second birefringent crystal, a lens, and a single-core waveguide that are successively arranged along the forward light path. The first birefringent crystal, the first Faraday rotator, and the second birefringent crystal are all parallel plate structures. The two cores of the dual-core polarization-maintaining waveguide are configured to import two linearly polarized lights which are aligned with their polarization states respectively, and output them to the first birefringent crystal; the o-light and e-light polarization states of the first birefringent crystal are aligned with the polarization states of the two linearly polarized lights respectively, and the first birefringent crystal is configured to form a first forward relative displacement between the two linearly polarized lights, and output them as the first crystal forward o-light and the first crystal forward e-light to the first Faraday rotator; the first Faraday rotator is configured to rotate the polarization states of the first crystal forward o-light and the first crystal forward e-light by an angle α in the first rotation direction and then output them to the second birefringent crystal, where α=45°; the second birefringent crystal is configured to form a second forward relative displacement between the first crystal forward o-light and the first crystal forward e-light, and the sum of the first forward relative displacement and the second forward relative displacement makes the first crystal forward o-light and the first crystal forward e-light overlap as a single beam and output it to the lens as divergent beam; the lens is configured to convert the divergent beam into convergent beam and output it to the single-core waveguide. When the backward light enters the single-core waveguide along the backward light path, the single-core waveguide is configured to output the backward light as divergent beam to the lens; the lens is configured to convert the backward light into convergent beam and output it to the second birefringent crystal; the second birefringent crystal is configured to form a second backward relative displacement between the two backward linearly polarized lights that are separated from the backward light and are in perpendicular polarization states to each other, and then output the two backward linearly polarized lights to the first Faraday rotator; the first Faraday rotator is configured to rotate the polarization states of the two backward linearly polarized lights by an angle α in the first rotation direction and then output them to the first birefringent crystal; the first birefringent crystal is configured to form a first backward relative displacement between the two backward linearly polarized lights. In the optical path between the forward input surface of the first birefringent crystal and the forward output surface of the second birefringent crystal, the polarization states of the two backward linearly polarized lights form a 90° rotation relative to the forward light with the o-light and e-light undergoing conversion in the first birefringent crystal, causing the optical path of the two backward linearly polarized lights in the first birefringent crystal to deviate from the forward light path in the first birefringent crystal, and ultimately, the two backward linearly polarized lights output from the first birefringent crystal cannot be coupled into any core of the dual-core polarization-maintaining waveguide.

### BRIEF DESCRIPTION OF THE DRAWINGS

Upon reading the detailed description of the preferred embodiment provided below, various other advantages and benefits will become clear to those skilled in the art. The accompanying drawings are merely for illustrating some exemplary embodiments, but shall not be construed as limiting the present disclosure. In the figures:

FIG. 1 is a schematic diagram of the optical path of an existing polarization beam splitter with isolation function;

FIG. 2a is a schematic diagram of the birefringence phenomenon and light displacement of a positive birefringent crystal according to an embodiment of present disclosure;

FIG. 2b is a schematic diagram of the birefringence phenomenon and light displacement of a positive birefringent crystal according to an embodiment of present disclosure;

FIG. 3a is a schematic diagram of the birefringence phenomenon and light displacement of a negative birefringent crystal according to an embodiment of present disclosure;

FIG. 3b is a schematic diagram of the birefringence phenomenon and light displacement of a negative birefringent crystal according to an embodiment of present disclosure;

FIG. 4 is a schematic diagram of the forward light path of a polarization beam splitter with single-stage isolation function provided in an embodiment of the present disclosure;

FIG. 5 is a schematic diagram of the backward light path of a polarization beam splitter with single-stage isolation function provided in an embodiment of the present disclosure;

FIG. 6a is a schematic diagram of the structure and optical axis of birefringent crystal A provided in an embodiment of the present disclosure;

FIG. 6b is a schematic diagram of the structure and optical axis of birefringent crystal B provided in an embodiment of the present disclosure;

FIG. 7a is a schematic diagram of the displacement of forward light and backward light in birefringent crystal A according to an embodiment of the present disclosure;

FIG. 7b is a schematic diagram of the displacement of forward light and backward light in birefringent crystal B according to an embodiment of the present disclosure;

FIG. 8a is a schematic diagram of the optical path of the first crystal forward o-light and the corresponding second crystal backward e-light in a polarization beam splitter according to the first embodiment of the present disclosure;

FIG. 8b is a schematic diagram of the optical path of the first crystal forward e-light and the corresponding second crystal backward o-light in a polarization beam splitter according to the first embodiment of the present disclosure;

FIG. 9a is a schematic diagram of the displacement of the forward light path in a polarization beam splitter according to the first embodiment of the present disclosure;

FIG. 9b is a schematic diagram of the displacement of the second crystal backward o-light in a polarization beam splitter according to the first embodiment of the present disclosure;

FIG. 9c is a schematic diagram of the displacement of the second crystal backward e-light in a polarization beam splitter according to the first embodiment of the present disclosure;

FIG. 10 is a schematic diagram of the forward light path of a polarization beam splitter with dual-stage isolation function according to an embodiment of the present disclosure;

FIG. 11 is a schematic diagram of the backward light path of a polarization beam splitter with dual-stage isolation function according to an embodiment of the present disclosure;

FIG. 12a is a schematic diagram of the structure and optical axis of birefringent crystal C according to an embodiment of the present disclosure;

FIG. 12b is a schematic diagram of the structure and optical axis of birefringent crystal D according to an embodiment of the present disclosure;

FIG. 12c is a schematic diagram of the structure and optical axis of birefringent crystal E according to an embodiment of the present disclosure;

FIG. 13a is a schematic diagram of the displacement of forward light and backward light in birefringent crystal C according to an embodiment of the present disclosure;

FIG. 13b is a schematic diagram of the displacement of forward light and backward light in birefringent crystal D according to an embodiment of the present disclosure;

FIG. 13c is a schematic diagram of the displacement of forward light and backward light in birefringent crystal E according to an embodiment of the present disclosure;

FIG. 14a is a schematic diagram of the first crystal forward o-light and the third crystal backward o-light in a polarization beam splitter according to the second embodiment of the present disclosure;

FIG. 14b is a schematic diagram of the first crystal forward e-light and the third crystal backward e-light in a polarization beam splitter according to the second embodiment of the present disclosure;

FIG. 15a is a schematic diagram of the displacement of the forward light path in a polarization beam splitter according to the second embodiment of the present disclosure;

FIG. 15b is a schematic diagram of the displacement of the third crystal backward o-light in a polarization beam splitter according to the second embodiment of the present disclosure;

FIG. 15c is a schematic diagram of the displacement of the third crystal backward e-light in a polarization beam splitter according to the second embodiment of the present disclosure;

FIG. 16a is a schematic diagram of the structure and optical axis of the first birefringent crystal as a combined crystal according to an embodiment of the present disclosure;

FIG. 16b is a schematic diagram of the structure and optical axis of the first birefringent crystal as a combined crystal according to another embodiment of the present disclosure;

FIG. 17 is a schematic diagram of the forward light path of a polarization beam combiner with single-stage isolation function according to an embodiment of the present disclosure;

FIG. 18 is a schematic diagram of the backward light path of a single-stage isolated polarization beam combiner with isolation function according to an embodiment of the present disclosure;

FIG. 19a is a schematic diagram of the first crystal forward o-light and the corresponding second crystal backward e-light in a polarization beam combiner according to the third embodiment of the present disclosure;

FIG. 19b is a schematic diagram of the first crystal forward e-light and the corresponding second crystal backward o-light in a polarization beam combiner according to the third embodiment of the present disclosure;

FIG. 20a is a schematic diagram of the displacement of the forward light path in a polarization beam combiner according to the third embodiment of the present disclosure;

FIG. 20b is a schematic diagram of the displacement of the second crystal backward o-light in a polarization beam combiner according to the third embodiment of the present disclosure;

FIG. 20c is a schematic diagram of the displacement of the second crystal backward e-light in a polarization beam combiner according to the third embodiment of the present disclosure;

FIG. 21a is a schematic diagram of the first crystal forward o-light and the third crystal backward o-light in a polarization beam combiner according to the fourth embodiment of the present disclosure;

FIG. 21b is a schematic diagram of the first crystal forward e-light and the third crystal backward e-light in a polarization beam combiner according to the fourth embodiment of the present disclosure;

FIG. 22a is a schematic diagram of the displacement of the forward light path in a polarization beam combiner provided in embodiment 4 of the present disclosure;

FIG. 22b is a schematic diagram of the displacement of the third crystal backward o-light in a polarization beam combiner according to the fourth embodiment of the present disclosure;

FIG. 22c is a schematic diagram of the displacement of the third crystal backward e-light in a polarization beam combiner according to the fourth embodiment of the present disclosure.

### DETAILED DESCRIPTION

The following will provide a detailed description of the embodiment of the technical solution of the embodiments of the present disclosure in conjunction with the drawings. These embodiments are merely used to more clearly illustrate the technical solution of the embodiments of the present disclosure and should not be used to limit the scope of protection of the present disclosure.

Unless otherwise defined, all technical and scientific terms used in this document have the same meaning as generally understood by those skilled in the technical field to which the present disclosure pertains; the terms used in this document are for the sole purpose of describing specific embodiments and are not intended to limit the present disclosure; the terms “comprising” and “having” and any variations thereof in the present disclosure's description and claims, as well as the drawings, are intended to cover non-exclusive inclusions.

In the description of the embodiments of the present disclosure, the technical terms “first,” “second,” and so on are used only to distinguish different objects and should not be understood to indicate or imply relative importance or to suggest a specific number, specific order, or hierarchy of the technical features indicated. In the description of the embodiments of the present disclosure, the term “multiple” means two or more, unless otherwise specifically limited.

The mention of “embodiment” in this document means that specific features, structures, or characteristics described in conjunction with the embodiment can be included in at least one embodiment of the present disclosure. The phrase appearing at various places in the specification does not necessarily refer to the same embodiment and is not an independent or alternative embodiment that is exclusive of other embodiments. Those skilled in the art understand both explicitly and implicitly that the embodiments described in this document can be combined with other embodiments.

In the description of the embodiments of the present disclosure, the term “and/or” is merely a descriptive association of related objects, indicating that there can be three relationships, for example, A and/or B, which can indicate: the presence of A, the presence of both A and B, or the presence of B alone. Additionally, the character “/” in this document generally indicates an “or” relationship between the associated objects before and after it.

In the description of the embodiments of the present disclosure, the term “multiple” refers to two or more (including two), similarly, “multiple sets” refers to two or more sets (including two sets), and “multiple pieces” refers to two or more pieces (including two pieces).

In the description of the embodiments of the present disclosure, the technical terms “center,” “longitudinal,” “transverse,” “length,” “width,” “thickness,” “top,” “bottom,” “front,” “back,” “left,” “right,” “vertical,” “horizontal,” “top,” “bottom,” “inside,” “outside,” “clockwise,” “counterclockwise,” “axial,” “radial,” and “circumferential” and other directional or positional relationships indicated are based on the orientation or position shown in the drawings, solely for the purpose of facilitating the description of the embodiments of the present disclosure and simplifying the description, and do not indicate or imply that the device or component referred to must have a specific orientation, be constructed and operated in a specific orientation, and therefore should not be understood as a limitation of the embodiments of the present disclosure.

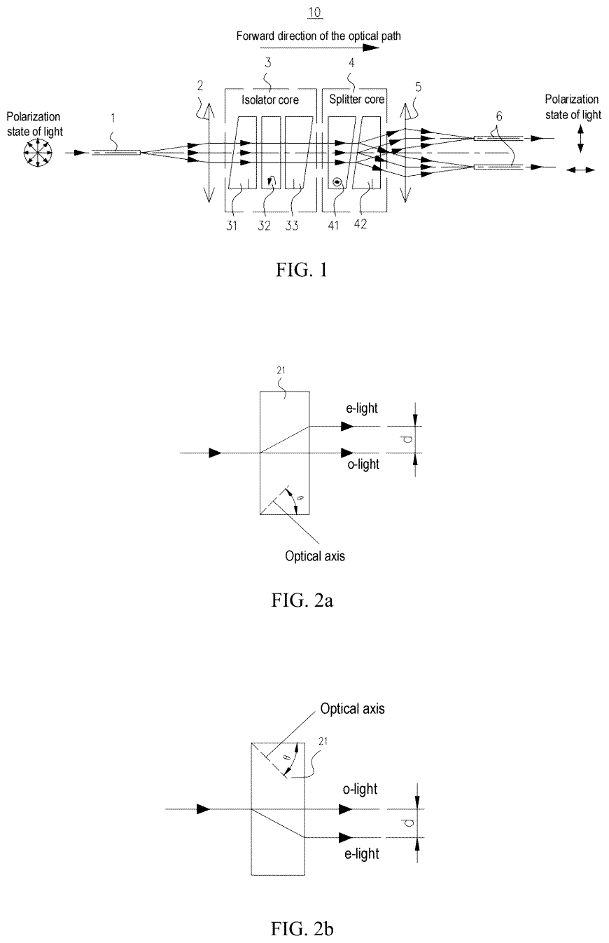

As shown in FIG. 1, the existing polarization beam splitter 10 with isolation function imports an arbitrary polarization state beam from waveguide 1 and outputs the divergent beam to the first lens 2, and then enters the isolator core 3 after being collimated into collimating beam by the first lens 2. The isolator core 3 includes a first wedge-shaped birefringent crystal 31, a Faraday rotator 32, and a second wedge-shaped birefringent crystal 33 along the forward light path successfully. The collimating beam enters the first wedge-shaped birefringent crystal 31 and is separated into the first crystal forward o-light and the first crystal forward e-light. The first crystal forward o-light forms a refraction angle λ and the first crystal forward e-light forms a refraction angle γ after passing through the first wedge-shaped birefringent crystal 31. The refraction angle refers to the angle between the exiting beam and the input collimating beam (i.e., the horizontal line). The first crystal forward o-light and the first crystal forward e-light have their polarization states rotated by 45° respectively after passing through the Faraday rotator 32. Then, the first crystal forward o-light enters the second wedge-shaped birefringent crystal 33 and align its polarization state with the o-light polarization state of the second wedge-shaped birefringent crystal 33. Similarly, the first crystal forward e-light enters the second wedge-shaped birefringent crystal 33 and align its polarization state with the e-light polarization state of the second wedge-shaped birefringent crystal 33. After passing through the second wedge-shaped birefringent crystal 33, the first crystal forward o-light forms a refraction angle −λ and the first crystal forward e-light forms a refraction angle −γ. The final refraction angles of both the first crystal forward o-light and the first crystal forward e-light after passing through the isolator core 3 are 0°, and both are output in a direction parallel to the incident beam. It should be noted that, since both the input beam and output beam of the isolator core 3 are collimating beams, for the sake of simplicity in FIG. 1, the specific refraction angles and optical paths of the first crystal forward o-light and the first crystal forward e-light are not shown. The specific principle of optical path refers to the above textual description.

Refer to FIG. 1 again; the first crystal forward o-light and the first crystal forward e-light outputting from the isolator core 3 enter the third wedge-shaped birefringent crystal 41 in the beam splitter core 4 as collimating beams. After passing through the third wedge-shaped birefringent crystal 41, the first crystal forward o-light forms a refraction angle −δ and exits towards the fourth wedge-shaped birefringent crystal 42, and the first crystal forward e-light forms a refraction angle −ε and exits towards the fourth wedge-shaped birefringent crystal 42. As shown in the figure, the optical axis of the third wedge-shaped birefringent crystal 41 is perpendicular to the optical axis of the fourth wedge-shaped birefringent crystal 42. Therefore, in the third wedge-shaped birefringent crystal 41 and the fourth wedge-shaped birefringent crystal 42, the polarization state of the first crystal forward o-light aligns with the o-light polarization state of one crystal and with the e-light polarization state of the other crystal. Thus, the first crystal forward o-light forms a refraction angle ε and the first crystal forward e-light forms a refraction angle δ after passing through the fourth wedge-shaped birefringent crystal 42. In the entire optical path of the beam splitter core 4, the total refraction angle for the first crystal forward o-light is −δ+ε, and the total refraction angle for the first crystal forward e-light is −ε+δ. Since the refraction angles of o-light and e-light in the wedge-shaped birefringent crystals are not equal, that is, δ≠ε, as shown in FIG. 1, the first crystal forward o-light and the first crystal forward e-light are finally deflected at certain angles and exit from the beam splitter core 4 in opposite directions. It should also be noted that the figure only schematically shows the two beams divided at the fourth wedge-shaped birefringent crystal 42, and the specific optical paths of o-light and e-light at the third wedge-shaped birefringent crystal 41 are not shown. The specific principle of optical path refers to the above textual content.

Ultimately, the first crystal forward o-light and the first crystal forward e-light outputting from the beam splitter core 4 form convergent beam after passing through the second lens 5 and are respectively output to the two cores of the dual-core waveguide 6, achieving the beam splitting function.

For the backward isolation function, the backward light path between the input end of the dual-core waveguide 6 and the output surface of the Faraday rotator 32 in the isolator core 3 is exactly the same as the forward light path. Since the Faraday rotator 32 rotates the polarization state of both the forward light and backward light in the same direction, that is, from the perspective of the left to right view in FIG. 1, the polarization state of both the forward light and backward light is rotated by 45° clockwise or 45° counterclockwise after passing through the Faraday rotator 32. Therefore, the polarization state of the backward light accumulates a 90° rotation relative to the forward light after the backward light passes through the Faraday rotator 32, and the o-light and e-light undergo transformation in the first wedge-shaped birefringent crystal 31. The refraction angles of the o-light and e-light in the wedge-shaped birefringent crystal are different. That is, if the polarization state of the fourth crystal backward o-light (the backward linearly polarized light aligned with the o-light polarization state of the fourth wedge-shaped birefringent crystal 42.) is aligned with the o-light of the second wedge-shaped birefringent crystal 33 and forms a refraction angle −λ after passing through the second wedge-shaped birefringent crystal 33, and the polarization state of the fourth crystal backward e-light (the backward linearly polarized light aligned with the e-light polarization state of the fourth wedge-shaped birefringent crystal 42.) is aligned with the e-light of the second wedge-shaped birefringent crystal 33 and forms a refraction angle −γ after passing through the second wedge-shaped birefringent crystal 33, the polarization state of the fourth crystal backward o-light is aligned with the e-light polarization state of the first wedge-shaped birefringent crystal 31 and the polarization state of the fourth crystal backward e-light is aligned with the o-light polarization state of the first wedge-shaped birefringent crystal after passing through the Faraday rotator 32, that is, the fourth crystal backward o-light forms a refraction angle γ, and the fourth crystal backward e-light forms a refraction angle λ. The cumulative refraction angle for the fourth crystal backward o-light is −λ+γ and that for the fourth crystal backward e-light is −γ+λ in the backward light path of the isolator core 3. Since the refraction angles of the o-light and e-light in the wedge-shaped birefringent crystal are not equal, that is, γ≠β, the fourth crystal backward o-light and the fourth crystal backward e-light eventually exit the isolator core 3 along two opposite refraction angles and cannot enter the waveguide 1 after passing through the first lens 2, achieving the isolation function for the backward light.

For a polarization beam combiner with isolation function, it can be realized by reversing the isolator core of the above polarization beam splitter with isolation function, and this will not be further elaborated here.

Based on the above scheme, current polarization beam splitters/combiners with isolation functions require the isolator core and beam splitter cores/combiner core at the same time, resulting in a complex structure, a multitude of optical parts, and consequently high costs.

In response, this embodiment of present disclosure utilizes the processing of convergent beam in birefringent crystals and Faraday rotator, and a rational combination and configuration of birefringent crystals and Faraday rotator, to form a set of polarization beam splitters/combiners with isolation function that is structurally simple and cost-effective.

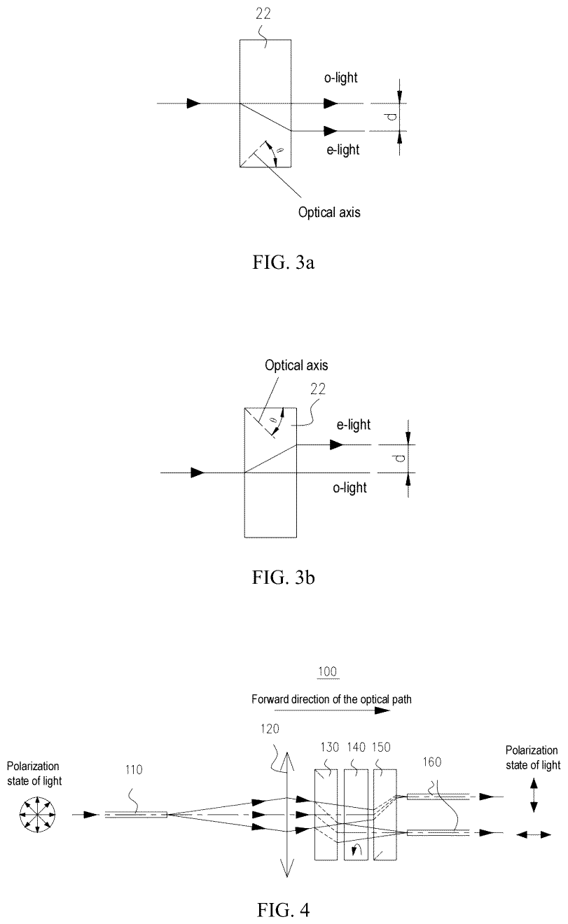

For the phenomena of crystal birefringence and light displacement, please refer to FIGS. 2a and 2b. Taking the normal incidence into a positive birefringent crystal 21 as an example, when the polarization state of the beam incident on the positive birefringent crystal 21 is not aligned with the o-light and e-light of the positive birefringent crystal 21, the beam will be separated into o-light and e-light within the positive birefringent crystal 21. The o-light follows the law of refraction and will not undergo any angular change, enter and exit the positive birefringent crystal 21 in the same direction as the incident light. The e-light, however, does not follow the law of refraction and will deviate within the positive birefringent crystal 21 and form a certain displacement d upon exiting the positive birefringent crystal 21. At this point, the relative displacement between the o-light and e-light is d. The birefringence and light displacement phenomena produced by normal incidence of a beam into a negative birefringent crystal 22 are shown in FIGS. 3a and 3b, which will not be further elaborated here.

Due to the opposite deflection directions of the e-light for positive birefringent crystals and negative birefringent crystals, for the sake of simplicity in statement, the positive birefringent crystal will be used as an example below. The angle θ between the optical axis of the birefringent crystal 21 and the normal to the incident surface is a walk-off angle. This walk-off angle θ is configured to control the relative displacement between the o-light and e-light after passing through the birefringent crystal 21. As shown in FIG. 2a, the e-light is deflected upwards forming a displacement d when 0°<θ<90°; as shown in FIG. 2b, the e-light is deflected downwards forming a displacement −d when −90°<θ<0°. Therefore, the relative displacement between the o-light and e-light can be adjusted by changing the θ angle.

According to one aspect of the embodiment of present disclosure, a polarization beam splitter with an isolation function is provided. Refer to FIG. 4 for details, FIG. 4 shows the structure of a polarization beam splitter with an isolation function as provided in one embodiment of present disclosure. As shown in the figure, the polarization beam splitter with an isolation function 100 includes: a single-core waveguide 110, a lens 120, a first birefringent crystal 130, a first Faraday rotator 140, a second birefringent crystal 150, and a dual-core polarization-maintaining waveguide 160 that are successively arranged along the forward light path, and the first birefringent crystal 130, the first Faraday rotator 140, and the second birefringent crystal 150 are all parallel plate structures.

For the beam splitting in the forward light path, as shown in FIG. 4, the single-core waveguide 110 is configured to import divergent beam and output it to the lens 120, where the divergent beam can be any polarization state. The lens 120 is configured to convert the divergent beam into convergent beam and output it to the first birefringent crystal 130.

The first birefringent crystal 130 is configured to separate the convergent beam into the first crystal forward o-light (the solid line in the first birefringent crystal 130 in FIG. 4 represents the light) and the first crystal forward e-light (the dash line in the first birefringent crystal 130 in FIG. 4 represents the light). The first crystal forward o-light and the first crystal forward e-light form a first forward relative displacement between them and then are output to the first Faraday rotator 140.

The first Faraday rotator 140 is configured to rotate the polarization states of the first crystal forward o-light and the first crystal forward e-light by an angle of α (45°) along the first rotation direction and then output them to the second birefringent crystal 150.

The second birefringent crystal 150 is configured to create a second forward relative displacement between the first crystal forward o-light and the first crystal forward e-light, and then output them to the two cores of the dual-core polarization-maintaining waveguide 160.

In the specific embodiment shown in FIG. 4, along the forward light path, the polarization state of the first crystal forward o-light is aligned with the polarization state of the e-light of the second birefringent crystal 150 after passing through the first Faraday rotator 140. As shown in FIG. 4, the convergent beam output from the lens 120 enters the first birefringent crystal 130, the beam that exits the first birefringent crystal 130 in the same direction as the input light and without optical path deviation is the first crystal forward o-light (the solid line in the first birefringent crystal 130 in FIG. 4 represents the beam). This first crystal forward o-light rotates the polarization state by 45° after passing through the first Faraday rotator 140 (which can be clockwise or counterclockwise). The rotated polarization state of the first crystal forward o-light is aligned with the e-light polarization state of the second birefringent crystal 150 and deviates in the optical path when exiting the second birefringent crystal 150 (the optical path of the first crystal forward o-light in the second birefringent crystal 150 is represented by the dash line in FIG. 4). The polarization state of the first crystal forward e-light is aligned with the o-light polarization state of the second birefringent crystal 150 after passing through the first Faraday rotator 140 and does not deviate in the optical path within the second birefringent crystal 150 (the optical path of the first crystal forward e-light in the second birefringent crystal 150 is represented by the solid line in FIG. 4). Ultimately, two beams are exited from the output surface of the second birefringent crystal 150, that are the first crystal forward o-light and the first crystal forward e-light with mutually perpendicular polarization states and separated positions. To achieve the beam splitting function in this embodiment, it is necessary to ensure that the sum of the displacements of the first crystal forward o-light and that of the first crystal forward e-light in the two crystals is not equal.

In alternative embodiments, along the forward light path, the polarization state of the first crystal forward o-light can also align with the o-light polarization state of the second birefringent crystal 150 after passing through the first Faraday rotator 140. The first crystal forward o-light enters and exits the second birefringent crystal 150 in the same direction as the input light and without any deviation of the optical path, while the first crystal forward e-light experiences deviation again within the second birefringent crystal 150. To achieve the beam splitting function in this embodiment, it is necessary to ensure that the sum of the displacements of the first crystal forward o-light and that of the first crystal forward e-light in the two crystals is not equal.

The distance between the two cores of the dual-core polarization-maintaining waveguide 160 is equal to the relative displacement formed by the sum of the first forward relative displacement and the second forward relative displacement between the first crystal forward o-light and the first crystal forward e-light. That is, the first crystal forward o-light and the first crystal forward e-light can enter the two cores of the dual-core polarization-maintaining waveguide 160 respectively after exiting the second birefringent crystal 150. The polarization states of the two cores of the dual-core polarization-maintaining waveguide 160 are aligned with the polarization states of the first crystal forward o-light and the first crystal forward e-light output from the second birefringent crystal 150. The dual-core polarization-maintaining waveguide 160 is then configured to export the first crystal forward o-light and the first crystal forward e-light, achieving the beam splitting function along the forward light path.

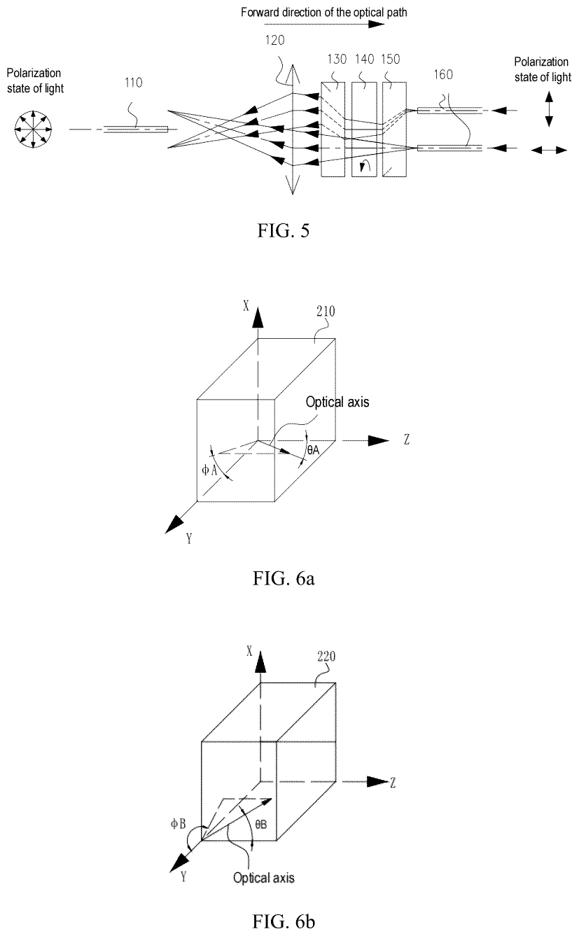

For the isolation function along the backward light path, as shown in FIG. 5, when two backward linearly polarized lights that are aligned with the polarization states of the two cores of the dual-core polarization-maintaining waveguide 160 enter the two cores of the dual-core polarization-maintaining waveguide 160 in the backward light path, the two cores of the dual-core polarization-maintaining waveguide 160 are configured to output the two backward linearly polarized lights to the second birefringent crystal 150, and the polarization states of the two backward linearly polarized lights are aligned with the o-light and e-light polarization states of the second birefringent crystal 150 respectively.

The second birefringent crystal 150 is configured to form a second backward relative displacement between the two backward linearly polarized lights and then output them to the first Faraday rotator 140. The first Faraday rotator 140 is configured to rotate the polarization states of the two backward linearly polarized lights by an angle of α (45°) in the first rotation direction and then output them to the first birefringent crystal 130. Regarding the rotation of the polarization state of the light by the Faraday rotator, it has been mentioned in the above text. Correspondingly, in FIG. 5, if viewed from left to right, both the forward light and the backward light rotate their polarization states in a clockwise direction or in a counterclockwise direction after passing through the first Faraday rotator 140. Therefore, the polarization states of the two backward linearly polarized lights undergo a 90° rotation in the first birefringent crystal 130 relative to the forward light after passing through the first Faraday rotator 140 and the o-light and e-light undergo transformation.

Based on this, the light paths of the forward light and that of the backward light are completely coincident from the backward input end of the dual-core polarization-maintaining waveguide 160 to the backward output surface of the first Faraday rotator 140, the transformation of o-light and e-light only occurs after the backward output surface of the first Faraday rotator 140.

Then the two backward linearly polarized lights enter the first birefringent crystal 130. The first birefringent crystal 130 is configured to create a first backward relative displacement between the two backward linearly polarized lights. As shown above, in the optical path between the forward input surface of the first birefringent crystal 130 and the forward output surface of the second birefringent crystal 150, the polarization states of the two backward linearly polarized lights undergo a 90° rotation relative to the forward light in the first birefringent crystal 130, the o-light and e-light undergo transformation. This causes the optical path of the two backward linearly polarized lights to deviate from the forward light path in the first birefringent crystal 130. Ultimately, the two backward linearly polarized lights output from the first birefringent crystal 130 cannot be coupled into the single-core waveguide 110 after passing through lens 120, achieving the backward isolation function.

For easy understanding of the specific embodiment, the following explanation takes the example that the forward light is normal incident into the first birefringent crystal 130. The same functionality provided in the embodiments of present disclosure also applies to the case of oblique incidence of forward light. First, two types of birefringent crystals are provided as examples for illustration. In the specific embodiment, different alignment methods of the o-light and e-light of these two birefringent crystals can form different schemes. Please refer to FIGS. 6a and 6b for details. FIG. 6a schematically shows the structure and optical axis of birefringent crystal A210, and FIG. 6b shows the structure and optical axis of birefringent crystal B220.

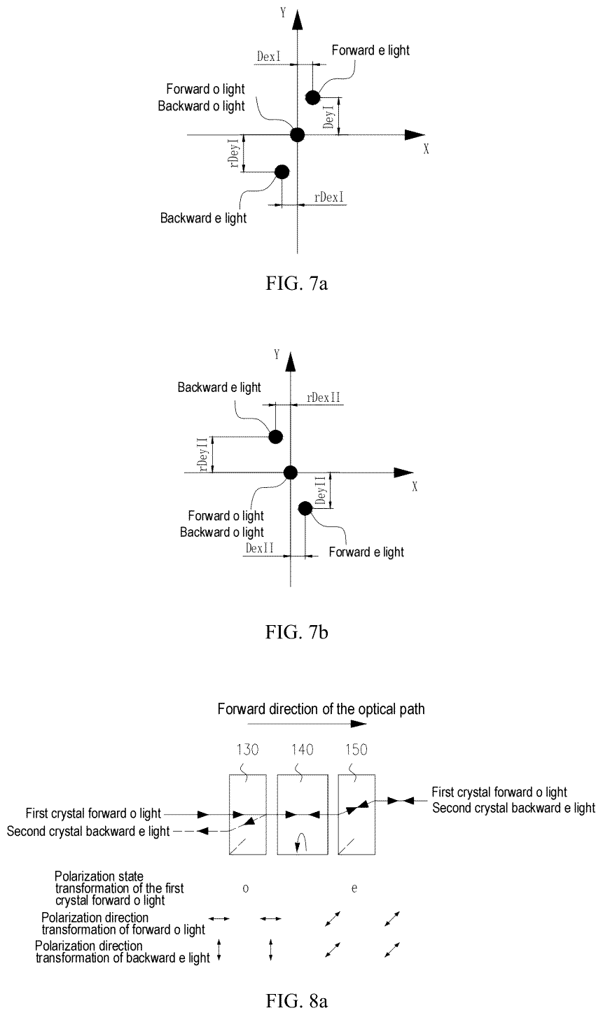

As shown in FIG. 6a, birefringent crystal A210 is a parallel plate structure, a three-dimensional Cartesian coordinate system is established with the incidence surface of the forward light as the xy plane where the x axis and y axis are located, and the forward light path as the positive direction of z-axis, where the normal to the forward light incidence surface of birefringent crystal A210 is parallel to the z-axis. The angle θA between the optical axis of birefringent crystal A210 and the normal to the forward light incidence surface (i.e., the z-axis) is its walk-off angle. The angle φA between the y-axis and the line where the e-light oscillation plane through the optical axis of birefringent crystal A210 intersects the xy plane is φA=22.5° in FIG. 6a. FIG. 7a shows a diagram of the light displacement in birefringent crystal A210. An x, y-axis Cartesian coordinate system on the incidence surface of birefringent crystal A210 is established with the forward light incidence point as the origin. Both the relative displacement of the forward light and the backward light are referred to the xyz coordinate system of the forward light. As shown in FIG. 7a, when the forward light is normally incident on birefringent crystal A210, the forward o-light follows the law of refraction and does not undergo displacement within the xy plane and exit the birefringent crystal A210 at the origin, that is, the forward o-light displacement in the x-axis direction of birefringent crystal A210 is DoxI=0, and the displacement in the y-axis direction is DoyI=0; the forward e-light does not follow the law of refraction and exit the birefringent crystal A210 with the x-axis direction displacement set to DexI=a and the y-axis direction displacement set to DeyI=a/tan(22.5°)=2.41 a. Correspondingly, the backward o-light with normal incidence also does not undergo displacement, and the backward e-light displacement in the x-axis and y-axis direction of birefringent crystal A210 is rDexI=−a and rDeyI=−2.41 a respectively. Of course, other displacement values can be adopted according to specific situations, and this is not limited here.

As shown in FIG. 6b, the birefringent crystal B220 is also a parallel plate structure, and a three-dimensional Cartesian coordinate system is established in the birefringent crystal B220 in the same manner as in birefringent crystal A210. The angle θB between the optical axis of birefringent crystal B220 and the normal to the forward light incidence surface (i.e., the z-axis) is its walk-off angle. The angle φB between the y-axis and the line where the e-light oscillation plane through the optical axis of birefringent crystal B220 intersects the xy plane is φB=157.5° in FIG. 6b. FIG. 7b shows a schematic diagram of the light displacement in birefringent crystal B220. The coordinate system is established and referenced in the same way as for the aforementioned birefringent crystal A210. As shown in FIG. 7b, the displacement of the forward e-light normal incident on birefringent crystal B220 is DexII=a and DeyII=a/tan(157.5°)=−2.41 a. Correspondingly, the displacement of the backward e-light normal incident on birefringent crystal B220 is rDexII=−a, rDeyII=2.41 a. Of course, other displacement values can be adopted according to specific situations, and this is not limited here.

### First Embodiment

In this embodiment, the first birefringent crystal 130 adopts the aforementioned birefringent crystal A210, and the second birefringent crystal 150 adopts the aforementioned birefringent crystal B220. The polarization state of the first crystal forward o-light in the first birefringent crystal 130 and the second birefringent crystal 150 is o-e along the forward light path.

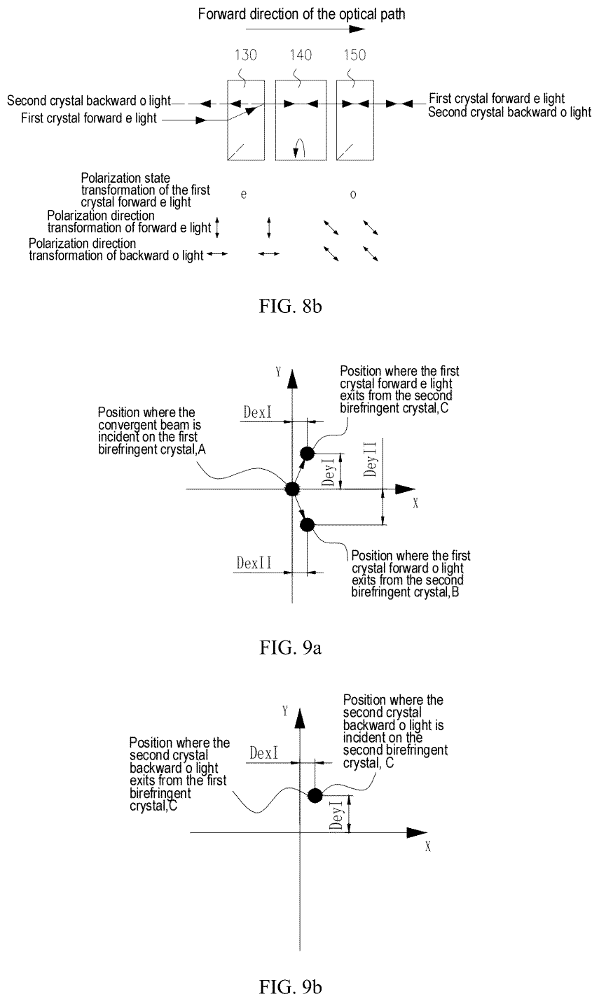

Refer to FIG. 8a for the polarization beam splitter with isolation function provided in First embodiment, it illustrates the optical path of the first crystal forward o-light and the optical path of the backward linearly polarized light (named as the second crystal backward e-light in the figure and below text) that input backward into the core of the dual-core polarization-maintaining waveguide 160 that receives the first crystal forward o-light. An xyz coordinate system is established with the forward direction of the optical path (from left to right) as the positive direction of z-axis as shown in the figure. The first crystal forward o-light will not deviate in the first birefringent crystal 130 and exit from the output surface of the first birefringent crystal 130 at the same xy coordinates as the incident surface; then the polarization state of the first crystal forward o-light rotates by 45° and aligns with the e-light polarization state of the second birefringent crystal 150 after passing through the first Faraday rotator 140; the first crystal forward o-light deviates in optical path when exiting from the second birefringent crystal 150 and then couples into one of the cores of the dual-core polarization-maintaining waveguide 160. For the second crystal backward e-light, the optical path of the second crystal backward e-light coincides with that of the first crystal forward o-light between the output surface of the second birefringent crystal 150 and the input surface of the first Faraday rotator 140 of the forward light path; however, the polarization state of the second crystal backward e-light rotates by 45° in the same direction as the forward light after passing through the first Faraday rotator 140. Since the first crystal forward o-light rotated its polarization state by 45° in the same direction when passing through the first Faraday rotator 140 in the forward light path, the second crystal backward e-light has accumulated a polarization rotation of 90° relative to the first crystal forward o-light. Specifically, the polarization direction changes of the first crystal forward o-light and the second crystal backward e-light is shown in FIG. 8a. The polarization state of the second crystal backward e-light is perpendicular to that of the first crystal forward o-light in the first birefringent crystal 130, and the polarization state of the second crystal backward e-light aligns with the e-light polarization state of the first birefringent crystal 130; then, the second crystal backward e-light deviates from the first crystal forward o-light after passing through the first birefringent crystal 130.

Refer to FIG. 8b for the polarization beam splitter with isolation function provided in First embodiment, it illustrates the optical path of the first crystal forward e-light and the optical path of the backward linearly polarized light (named as the second crystal backward o-light in the figure and below text) that input backward into the core of the dual-core polarization-maintaining waveguide 160 that receives the first crystal forward e-light. As shown in figure, the first crystal forward e-light deviates in and exits from the first birefringent crystal 130 in the forward light path; then the polarization state of the first crystal forward e-light rotates by 45° and aligns with the o-light polarization state of the second birefringent crystal 150 after passing through the first Faraday rotator 140; the first crystal forward e-light does not deviate in the second birefringent crystal 150 and exits from the output surface of the second birefringent crystal 150 at the same xy coordinates as the incident surface and then couples into the other core of the dual-core polarization-maintaining waveguide 160. For the second crystal backward o-light, similarly, the optical path of the second crystal backward o-light coincides with that of the first crystal forward e-light between the output surface of the second birefringent crystal 150 and the input surface of the first Faraday rotator 140 of the forward light path; the polarization state of the second crystal backward o-light rotates by 45° in the same direction as the forward light after passing through the first Faraday rotator 140 and has accumulated a polarization rotation of 90° relative to the first crystal forward e-light. Specifically, the polarization direction changes of the first crystal forward e-light and the second crystal backward o-light is shown in FIG. 8b. The polarization state of the second crystal backward o-light is perpendicular to that of the first crystal forward e-light in the first birefringent crystal 130, and the polarization state of the second crystal backward o-light aligns with the o-light polarization state of the first birefringent crystal 130; thus the second crystal backward o-light exits from the output surface of the first birefringent crystal 130 at the same xy coordinates as the incident surface and then deviates from the first crystal forward e-light.

In summary, combining FIG. 8a and FIG. 8b, it can be seen that both the second crystal backward e-light and the second crystal backward o-light cannot enter the single-core waveguide 110 after passing through the first birefringent crystal 130, and achieve the backward isolation.

In present embodiment and as shown in FIGS. 8a and 8b, the first crystal forward o-light and the first crystal forward e-light have different refractive indices in the first birefringent crystal 130. Therefore, the optical path of the first crystal forward o-light is not equal to that of the first crystal forward e-light in the first birefringent crystal 130 and results in an optical path difference. The first crystal forward o-light propagates as e-light in the second birefringent crystal 150, and the first crystal forward e-light propagates as o-light in the second birefringent crystal 150. Thus, the second birefringent crystal 150 can reduce the optical path difference generated between the first crystal forward o-light and the first crystal forward e-light in the first birefringent crystal 130. Furthermore, by controlling the optical path difference between the first crystal forward o-light and the first crystal forward e-light in the first birefringent crystal 130, and the optical path difference in the second birefringent crystal 150, the optical path difference can be completely compensated and eliminated when the absolute values of the two optical path differences are equal.

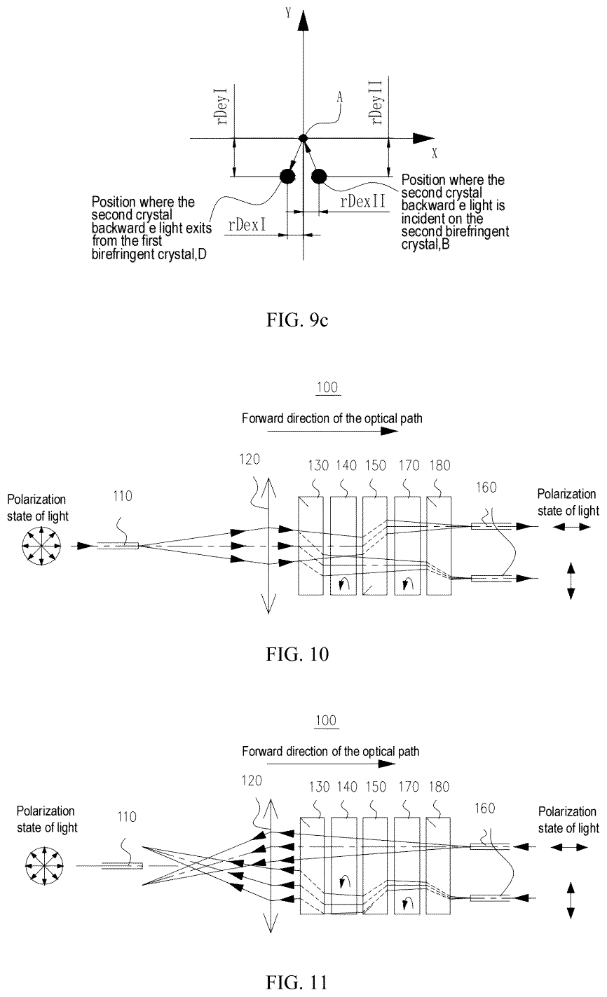

To more clearly illustrate the forward beam splitting and the backward isolation, this embodiment also provides a schematic diagram of the projection positions of the beam's entry and exit points on the xy plane in each birefringent crystal. Refer to FIGS. 9a to 9c for details. FIG. 9a shows a schematic diagram of the displacement of the forward lights, FIG. 9b shows a schematic diagram of the displacement of the second crystal backward e-light, and FIG. 9c shows a schematic diagram of the displacement of the second crystal backward o-light.

As shown in FIG. 9a, the convergent beam output from lens 120 is incident on the first birefringent crystal 130 at point A (the origin of coordinate system) and then is separated into o-light and e-light that are called the first crystal forward o-light and the first crystal forward e-light. The first crystal forward o-light does not deviate in the first birefringent crystal 130 and still exits at point A (0,0); the first crystal forward e-light generates the displacements of DexI=a and DeyI=2.41 a along the x-axis and y-axis respectively, and exit at point C (a, 2.41 a), resulting in a first relative displacement between the first crystal forward o-light and the first crystal forward e-light. After passing through the first Faraday rotator, the first crystal forward o-light propagates in the second birefringent crystal 150 as e-light and generates the displacements of DexII=a and DeyII=−2.41 a along the x-axis and y-axis respectively, and exit at point B (a, −2.41 a); the first crystal forward e-light propagates in the second birefringent crystal 150 as o-light, there is no displacement. Based on this, the coordinates of the entry point A of the first crystal forward o-light are (0,0), and the exit point B has an x-axis coordinate Dox=DoxI+DexII=0+a=a and a y-axis coordinate Doy=DoyI+DeyII=0+(−2.41 a)=−2.41 a, so the coordinates of point B are (a, −2.41 a); the coordinates of the entry point A of the first crystal forward e-light are (0,0), and the exit point C has an x-axis coordinate Dex=DexI+DoxII=a+0=a and a y-axis coordinate Dey=DeyI+DoyII=2.41 a+0=2.41 a, so the coordinates of point C are (a, 2.41 a). The position of two cores of the dual-core polarization-maintaining waveguide 160 are aligned with points B and C and the polarization states of the two cores are aligned with the e-light and o-light polarization states of the second birefringent crystal 150 respectively.

As shown in FIGS. 9b and 9c, the second crystal backward o-light enters the second birefringent crystal at point C and propagates in the o-light polarization state within the second birefringent crystal 150, and also propagates in the o-light polarization state within the first birefringent crystal 130 after being rotated by the first Faraday rotator. The final exit coordinates are calculated as rDox=Dex+rDoxII+rDoxI=a+0+0=a, rDoy=Dey+rDoyII+rDoyI=2.41 a+0+0=2.41 a, exiting the first birefringent crystal at point C (a, 0). The second crystal backward e-light enters the second birefringent crystal at point B and propagates in the e-light polarization state within the second birefringent crystal 150, and also propagates in the e-light polarization state within the first birefringent crystal 130 after being rotated by the first Faraday rotator. The final exit coordinates are calculated as rDex=Dox+rDexII+rDexI=a+(−a)+(−a)=−a, rDey=Doy+rDeyII+rDeyI=−2.41 a+2.41 a+(−2.41 a)=−2.41 a, exiting the first birefringent crystal at point D (−a, −2.41 a). Based on this, both the exit point C (a, 2.41 a) of the second crystal backward o-light and the exit point D (−a, −2.41 a) of the second crystal backward e-light deviate from the incidence point A (0, 0) of the forward convergent beam, thus the backward light cannot be coupled into the single-core waveguide 110 through the lens 120, achieving the backward isolation function.

In other embodiments, the structure of the birefringent crystals and the arrangement of the optical path are the same as in the aforementioned first embodiment, the only difference is that the rotation direction of the Faraday is changed and make the polarization state of the first crystal forward o-light in the first birefringent crystal 130 and in the second birefringent crystal 150 as o-o. By reasonably setting the dual-core spacing and polarization direction of the dual-core polarization-maintaining waveguide, the polarization beam splitting and backward isolation functions can also be achieved too. The specific changes in polarization state and beam displacement are same and will not be further elaborated here.

Finally, it should be noted that the above embodiments are provided as exemplary illustrations, and the deviation, deviation direction, deviation distance of the optical path will not be the limitation to present disclosure. Based on the structure proposed in this embodiment, all schemes that achieve forward beam splitting and backward beam isolation by reasonably designing the structure, optical axis and the polarization state relationship of the o-light and e-light of the first birefringent crystal 130 and the second birefringent crystal 150 should be included within the scope of protection of present disclosure.

The polarization beam splitter with isolation function 100 provided in present embodiment performs forward beam splitting and backward isolation for the convergent beam, requiring a small number of optical parts which is conducive to reducing production costs. Moreover, the first birefringent crystal 130, the first Faraday rotator 140, and the second birefringent crystal 150 are all parallel plate structures, which are simple in structure and easy to manufacture.

In the embodiment, the angle θ1 between the normal to the forward light incidence surface and the optical axis of the first birefringent crystal 130 is the first walk-off angle, with −90°<θ1<0° or 0°<θ1<90°. The first walk-off angle is configured to control the first forward relative displacement in the first birefringent crystal 130 between the first crystal forward o-light and the first crystal forward e-light, and the first backward relative displacement in the first birefringent crystal 130 between the second crystal backward o-light and the second crystal backward e-light.

In the embodiment, the angle θ2 between the normal to the forward light incidence surface and the optical axis of the second birefringent crystal 150 is the second walk-off angle, with −90°<θ2<0° or 0°<θ2≤90°. The second walk-off angle is configured to control the second forward relative displacement in the second birefringent crystal 150 between the first crystal forward o-light and the first crystal forward e-light, and the second backward relative displacement in the second birefringent crystal 150 between the second crystal backward o-light and the second crystal backward e-light, as well as the cumulative optical path difference between the o-light and e-light in both the first birefringent crystal 130 and the second birefringent crystal 150.

In the embodiment, an xyz coordinate system is established with the forward direction of the optical path (from left to right) as the positive direction of z-axis. The e-light oscillation plane through the optical axis of the first birefringent crystal 130 intersects the xy plane at the first line, and the angle between the first line and the y-axis is φ1. The e-light oscillation plane through the optical axis of the second birefringent crystal 150 intersects the xy plane at the second line, and the angle between the second line and the y-axis is φ2. The relationship is set as |φ2−φ1|=(m·90°+α), where m=1 or 3.

φ1 can refer to the description of φA of birefringent crystal A210 in FIG. 6a; φ2 can refer to the description of φB of birefringent crystal B220 in FIG. 6b. By setting the relationship between φ1 and φ2 as |φ2−φ1|=(m·90°+α), where m=1 or 3, it ensures that the polarization state of the first crystal forward o-light exiting the first birefringent crystal 130 can align with the o-light or e-light of the second birefringent crystal 150 after passing through the first Faraday rotator 140. The specific values are φ1=22.5° and φ2=157.5°, satisfying the condition |φ2−φ1|=(m·90°+α), where m=1 or 3.

The aforementioned backward isolation function achieved by two birefringent crystals (the first birefringent crystal 130 and the second birefringent crystal 150) and one Faraday rotator (the first Faraday rotator 140) is called single-stage isolation. To achieve better isolation, the number of Faraday rotators and birefringent crystals can be increased to form a dual-stage isolation.

Specifically, refer to FIG. 10, the polarization beam splitter 100 with a dual-stage isolation function includes: a second Faraday rotator 170 and a third birefringent crystal 180 which are set along the forward light path successively and between the second birefringent crystal 150 and the dual-core polarization-maintaining waveguide 160. Both the second Faraday rotator 170 and the third birefringent crystal 180 are parallel plate structures. The angle θ2 between the normal to the forward light incidence surface of the second birefringent crystal 150 and the optical axis of the second birefringent crystal 150 is the second walk-off angle, with −90°<θ2<0° or 0°<θ2<90°. The second walk-off angle is configured to control the second forward relative displacement and the second backward relative displacement. The angle θ3 between the normal to the forward light incidence surface of the third birefringent crystal 180 and the optical axis of the third birefringent crystal 180 is the third walk-off angle, with −90°≤θ3<0° or 0°<θ3≤90°. The third walk-off angle is configured to control the third forward relative displacement and the third backward relative displacement, as well as the cumulative optical path difference between the o-light and e-light among the first birefringent crystal 130, the second birefringent crystal 150 and the third birefringent crystal 180.

An xyz coordinate system is established with the backward direction of light path as the positive direction of z-axis, the e-light oscillation plane through the optical axis of the second birefringent crystal 150 intersects the xy plane at the second line, and the angle between the second line and the y-axis is φ2. The e-light oscillation plane through the optical axis of the third birefringent crystal 180 intersects the xy plane at the third line, and the angle between the third line and the y-axis is φ3, where |φ3−φ2|=(m·90°±β), m=1 or 3, and β=45°.

For the forward light path, as shown in FIG. 10, the second birefringent crystal 150 is configured to output the first crystal forward o-light and the first crystal forward e-light to the second Faraday rotator 170. The second Faraday rotator 170 is configured to rotate the first crystal forward o-light and the first crystal forward e-light by β angle) (45°) in the second rotation direction, and then output them to the third birefringent crystal 180. The third birefringent crystal 180 is configured to form a third forward relative displacement between the first crystal forward o-light and the first crystal forward e-light, and then output them to the two cores of the dual-core polarization-maintaining waveguide 160 respectively. The polarization states of the two cores of the dual-core polarization-maintaining waveguide 160 are aligned with the polarization states of the first crystal forward o-light and the first crystal forward e-light output from the third birefringent crystal 180. The distance between the two cores of the dual-core polarization-maintaining waveguide 160 is equal to the sum of the first forward relative displacement, the second forward relative displacement, and the third forward relative displacement between the first crystal forward o-light and the first crystal forward e-light.

For the backward light path, as shown in FIG. 11, when two backward linearly polarized lights enter the two cores of the dual-core polarization-maintaining waveguide 160, the two cores of the dual-core polarization-maintaining waveguide 160 are configured to respectively output the two backward linearly polarized lights to the third birefringent crystal 180. The polarization states of the two backward linearly polarized lights are respectively aligned with the o-light and e-light polarization states of the third birefringent crystal 180. The third birefringent crystal 180 is configured to create a third backward relative displacement between the two backward linearly polarized lights, and then outputs them as the third crystal backward o-light and the third crystal backward e-light to the second Faraday rotator 170. The second Faraday rotator 170 is configured to rotate the polarization states of the third crystal backward o-light and the third crystal backward e-light by β angle (45°) in the second rotation direction, and then outputs them to the second birefringent crystal 150. The second birefringent crystal 150 is configured to create a second backward relative displacement between the third crystal backward o-light and the third crystal backward e-light, and then outputs them to the first Faraday rotator 140. In the optical path between the forward input surface of the second birefringent crystal 150 and the forward output surface of the third birefringent crystal 180, the polarization states of the third crystal backward o-light and the third crystal backward e-light undergo a 90° rotation relative to the forward light in the second birefringent crystal 150, the o-light and e-light undergo transformation. This causes the optical path of the third crystal backward o-light and the third crystal backward e-light to deviate from the forward light path in the second birefringent crystal 150. The first Faraday rotator 140 is configured to rotate the polarization states of the third crystal backward o-light and the third crystal backward e-light by an α angle (45°) in the first rotation direction, and then outputs them to the first birefringent crystal 130. The first birefringent crystal 130 is configured to create a first backward relative displacement between the third crystal backward o-light and the third crystal backward e-light. In the optical path between the forward input surface of the first birefringent crystal 130 and the forward output surface of the second birefringent crystal 150. For the forward and backward light with the same polarization state (o-light or e-light) in the second birefringent crystal 150, the polarization state of the backward light is cumulatively rotated by 90° relative to the forward light after being rotated by the first Faraday rotator 140 by an α angle (45°) in the first rotation direction, the o-light and e-light undergo transformation in the first birefringent crystal 130, causing the third crystal backward o-light and the third crystal backward e-light to deviate once again from the forward light path in the first birefringent crystal 130, forming a second isolation. The sum of the third backward relative displacement, the second backward relative displacement, and the first backward relative displacement ultimately causes the third crystal backward o-light and the third crystal backward e-light output from the first birefringent crystal 130 to deviate from the forward light path and cannot be coupled into the single-core waveguide 110 after passing through lens 120.

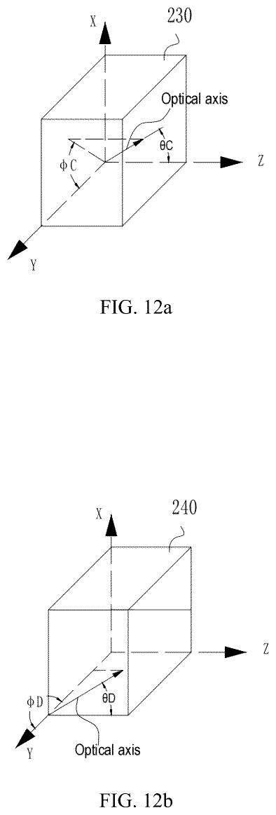

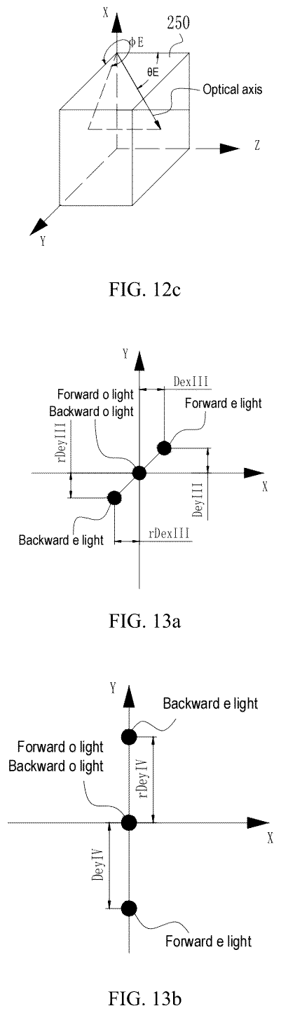

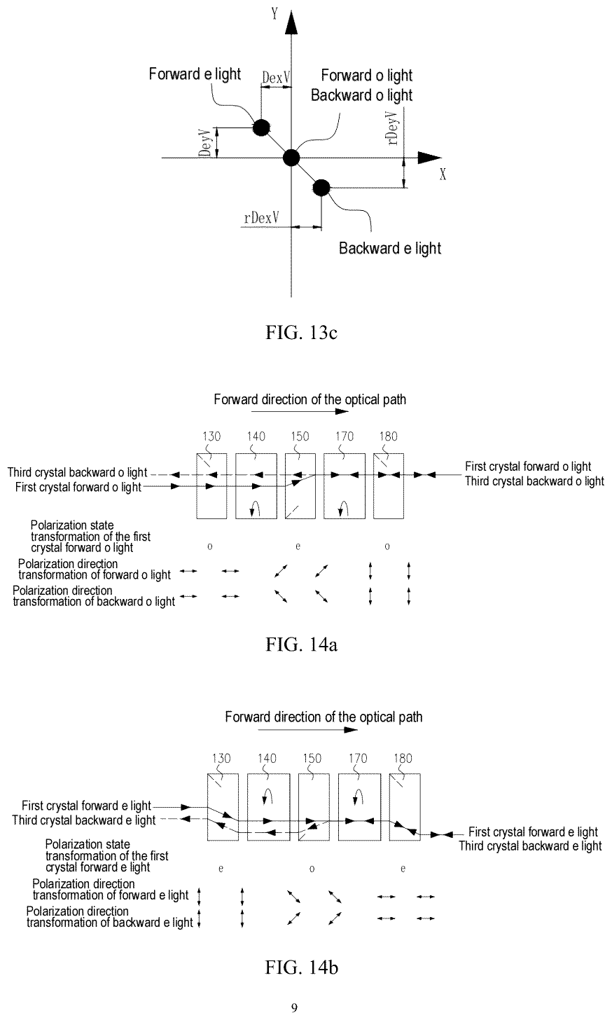

Please refer to FIGS. 12a to 12c, that illustrate the structures and the optical axes of several different birefringent crystals. As shown in FIG. 12a, the birefringent crystal C230 is a parallel plate structure. A three-dimensional Cartesian coordinate system is established with the forward light incidence surface as the xy plane and the forward direction of light path as the positive direction of z-axis, where the normal to the forward light incidence surface of the birefringent crystal C230 is parallel to the z-axis. The angle θC between the optical axis of the birefringent crystal C230 and the normal to the forward light incidence surface (i.e., the z-axis) is its walk-off angle. The e-light oscillation plane through the optical axis of the birefringent crystal C230 intersects the xy plane at a line, an angle φC between the line and the y-axis is formed, where φC=45° in FIG. 12a. FIG. 13a shows a schematic diagram of the light displacement in the birefringent crystal C230, the coordinate system is established and referenced in the same way as for the aforementioned birefringent crystals A210 and B220. As shown in FIG. 13a, the displacement of the forward o-light in the x-axis direction is DoxIII=0, and that in the y-axis direction is DoyIII=0; the displacement of the forward e-light in the x-axis direction is DexIII=a, and that in the y-axis direction is DeyIII=a/tan(45°)=a; the displacement of the backward o-light in the x-axis direction is rDoxIII=0, and that in the y-axis direction is rDoyIII=0; the displacement of the backward e-light in the x-axis direction is rDexIII=−a, and that in the y-axis direction is rDeyIII=−a/tan(45°)=−a.

Similarly, as shown in FIG. 12b, the birefringent crystal D240 is a parallel plate structure and its walk-off angle is θD. The e-light oscillation plane through the optical axis of the birefringent crystal D240 intersects the xy plane at a line, an angle φD between the line and the y-axis is formed, where φD=180° in FIG. 12b. FIG. 13b shows a schematic diagram of the light displacement in the birefringent crystal D240. As shown in the figure, the displacement of the forward o-light in the x-axis direction is DoxIV=0, and that in the y-axis direction is DoyIV=0; the displacement of the forward e-light in the x-axis direction is DexIV=0, and that in the y-axis direction is DeyIV=−3 a; the displacement of the backward o-light in the x-axis direction is rDoxIV=0, and that in the y-axis direction is rDoyIV=0; the displacement of the backward e-light in the x-axis direction is rDexIV=0, and that in the y-axis direction is rDeyIV=3 a.

As shown in FIG. 12c, the birefringent crystal E250 is a parallel plate structure and its walk-off angle is θE. The e-light oscillation plane through the optical axis of the birefringent crystal E250 intersects the xy plane at a line, an angle φE between the line and the y-axis is formed, where φE=315° in FIG. 12c. FIG. 13c shows a schematic diagram of the light displacement in the birefringent crystal E250. As shown in the figure, the displacement of the forward o-light in the x-axis direction is DoxV=0, and that in the y-axis direction is DoyV=0; the displacement of the forward e-light in the x-axis direction is DexV=−a, and that in the y-axis direction is DeyV=−a/tan(315°)=a; the displacement of the backward o-light in the x-axis direction is rDoxV=0, and that in the y-axis direction is rDoyV=0; the displacement of the backward e-light in the x-axis direction is rDexV=a, and that in the y-axis direction is rDeyV=−a.

For the polarization beam splitter with dual-stage isolation function, the present disclosure provides the following embodiment to illustrate:

### Second Embodiment

In this embodiment, the first birefringent crystal 130 adopts the aforementioned birefringent crystal C230, the second birefringent crystal 150 adopts the aforementioned birefringent crystal D240, and the third birefringent crystal 180 adopts the aforementioned birefringent crystal E250. Along the forward light path, the polarization state of the first crystal forward o-light in the first birefringent crystal 130, the second birefringent crystal 150 and the third birefringent crystal 180 is o-e-o respectively.

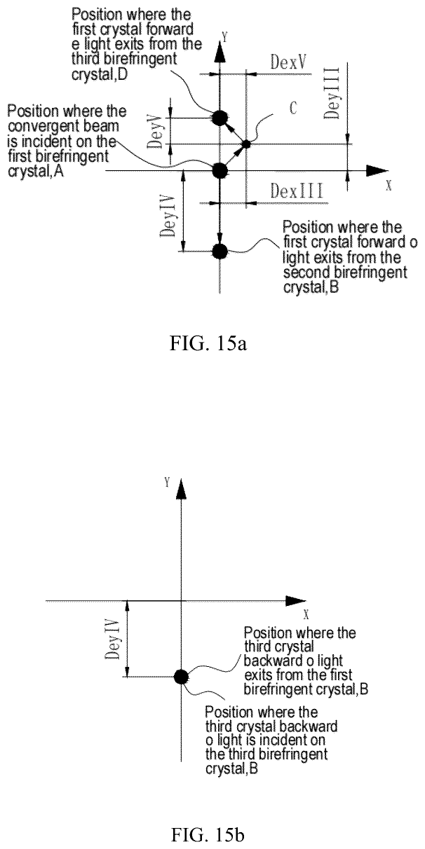

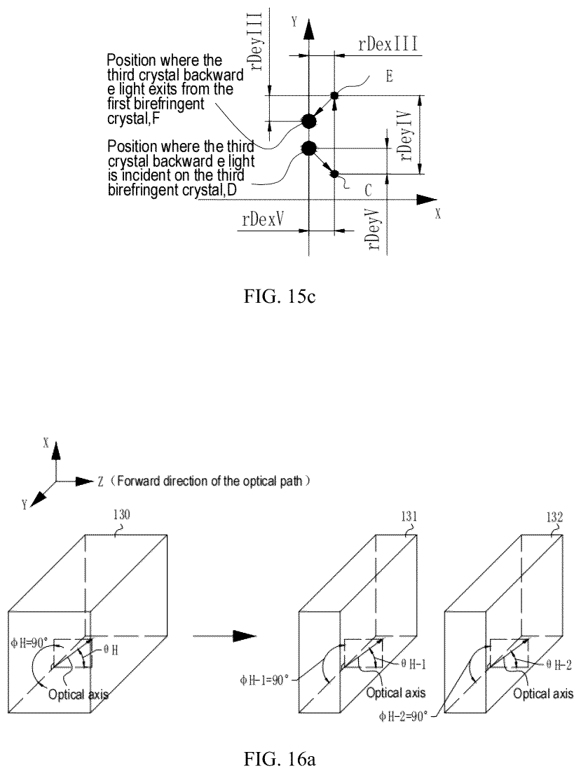

In this embodiment, the optical path and polarization state changes of the first crystal forward o-light and its corresponding third crystal backward o-light are shown in FIG. 14a, and the optical path and polarization state changes of the first crystal forward e-light and its corresponding third crystal backward e-light are shown in FIG. 14b. The displacements of the forward light and backward lights are shown in FIGS. 15a to 15c. The content and related principles shown in the figures are consistent with that in the aforementioned First embodiment, and will not be further elaborated here. Ultimately, the exit points of the first crystal forward o-light and the first crystal forward e-light are point B (0, −3 a) and point D (0, 2 a) respectively, and the two cores of the dual-core polarization-maintaining waveguide 160 are aligned with points B and D respectively. The exit points of the third crystal backward o-light and the third crystal backward e-light are point B (0, −3 a) and point F (0, 3 a) respectively, neither of them can be backward coupled into the single-core waveguide 110, achieving backward isolation.

In other embodiments, the structure of the birefringent crystals and the arrangement of the optical paths are the same as in the aforementioned second embodiment, the difference is the polarization state of the first crystal forward o-light in the first birefringent crystal 130, the second birefringent crystal 150 and the third birefringent crystal 180 are one of o-o-o, o-o-e, or o-e-e. The polarization state changes and light displacements are same in principle, and will not be further elaborated here.

it should be noted that the above embodiments are provided as exemplary illustrations, and the deviation, deviation direction, deviation distance of the optical path will not be the limitation to present disclosure. Based on the structure proposed in this embodiment, all schemes that achieve forward beam splitting and backward beam isolation by reasonably designing the structure, optical axis and the polarization state relationship of the o-light and e-light of the first birefringent crystal 130, the second birefringent crystal 150 and the third birefringent crystal 180 should be included within the scope of protection of present disclosure.

The polarization beam splitter with isolation function 100 provided in present embodiment includes: a first birefringent crystal 130, a first Faraday rotator 140, a second birefringent crystal 150, a second Faraday rotator 170, and a third birefringent crystal 180, all of them are parallel plate structures and are arranged successively. A dual-stage and enhanced isolation effect to the backward light beam is achieved while ensuring the simple structure and easy manufacturing.

Furthermore, in some embodiments, the first birefringent crystal 130, and/or the second birefringent crystal 150, and/or the third birefringent crystal 180 is a combined crystal. The combined crystal is configured to form the same relative displacement and to compensate for the optical path difference.

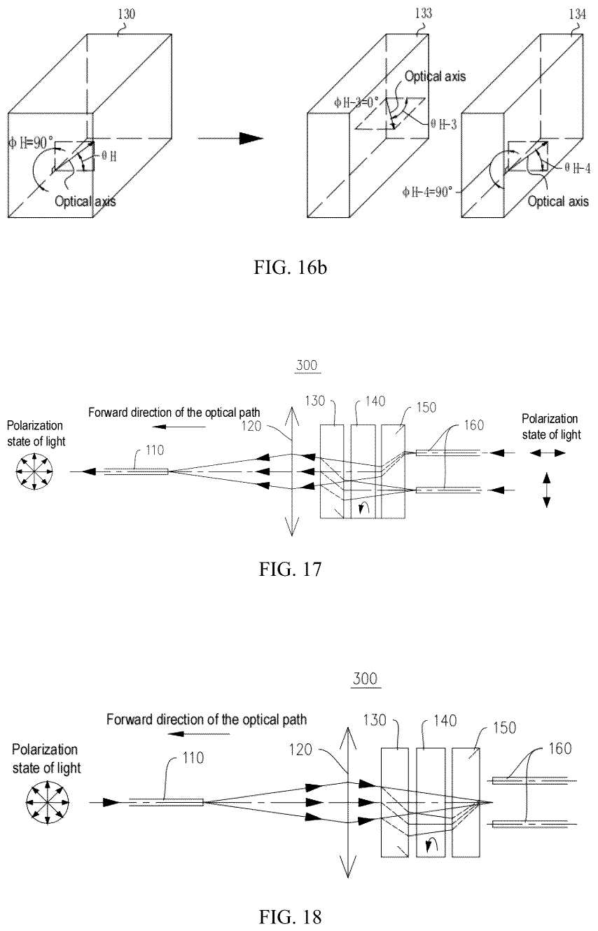

Specifically, refer to FIGS. 16a and 16b, they provide two exemplary explanations taking the first birefringent crystal 130 as a combined crystal. As shown in FIG. 16a, a coordinate system is established with the incidence surface as the x-y plane and the forward direction of the optical path as the positive direction of z-axis, the first birefringent crystal 130 is composed of a sub-birefringent crystal 131 and a sub-birefringent crystal 132. The φH-1 of the sub-birefringent crystal 131 is the same as the φH-2 of the sub-birefringent crystal 132, and the sub-birefringent crystal 131 satisfies 0°<θH-1<90° and the sub-birefringent crystal 132 satisfies 0°<θH-2≤90°. The positions of sub-birefringent crystals 131 and 132 can be interchanged to achieve the same function. As shown in FIG. 16b, the first birefringent crystal 130 can also be composed of a sub-birefringent crystals 133 and a sub-birefringent crystals 134. The φ angles of sub-birefringent crystals 133 and 134 differ by 90° or 270°, and the sub-birefringent crystal 133 satisfies 0°<θH-3≤90° and the sub-birefringent crystal 134 satisfies 0°<θH-4<90°. The positions of sub-birefringent crystals 133 and 134 can be interchanged to achieve the same function. The same applies to the second birefringent crystal 150 and the third birefringent crystal 180, and will not be further elaborated here.

Taking the first birefringent crystal 130 as an example of a combined crystal, the sum of the relative displacements of the forward light in the two sub-birefringent crystals forms a displacement identical to the first forward relative displacement in the aforementioned first birefringent crystal 130. The combined crystal can be configured to compensate for the optical path difference generated in a single birefringent crystal, or it can be configured to compensate for the optical path differences generated in multiple birefringent crystals along the entire optical path. When compensating for the optical path difference of a single crystal, it can be configured with the o-light and e-light polarization states interchanged in two sub-birefringent crystals that are either both positive birefringent crystals or both negative birefringent crystals, thereby reducing the total optical path difference. Alternatively, the two sub-birefringent crystals can consist of one positive birefringent crystal and one negative birefringent crystal with the same polarization state (both o-light or both e-light) maintained in two sub-birefringent crystals, thus reducing the optical path difference. By properly setting the θ angle and the thickness of the sub-birefringent crystals, the optical path difference between the o-light and e-light in each sub-birefringent crystal can be adjusted. When compensating for the optical path difference of the entire optical path, the sub-birefringent crystal used in the combined crystal to compensate for the optical path difference must not only achieve the same displacement change with the other sub-birefringent crystal in the combined crystal but also have its own optical path difference between o-light and e-light configured in the opposite direction to the sum of the optical path differences of the other birefringent crystals in the entire optical path. This reduces the total optical path difference and can even make the optical path difference zero, achieving the function of compensating for the optical path difference of the entire optical path.

According to another aspect of the embodiment of present disclosure, a polarization beam combiner with isolation function is also provided. Please refer to FIGS. 17 and 18 for details, which respectively illustrate the forward light path and backward light path of the beam combiner. The polarization beam combiner with isolation function 300 includes a dual-core polarization-maintaining waveguide 160, a first birefringent crystal 150, a first Faraday rotator 140, a second birefringent crystal 130, a lens 120, and a single-core waveguide 110, which are successively arranged along the forward light path. The first birefringent crystal 150, the first Faraday rotator 140, and the second birefringent crystal 130 are all parallel plate structures.

As shown in FIG. 17, the dual-core polarization-maintaining waveguide 160 is configured to import two linearly polarized lights which polarization states are aligned with the polarization states of the dual-core polarization-maintaining waveguide 160 respectively, and output them to the first birefringent crystal 150. The o-light and e-light polarization states of the first birefringent crystal 150 are aligned with the polarization states of the two linearly polarized lights respectively. The first birefringent crystal 150 is configured to create a first forward relative displacement between the two linearly polarized lights and output them as the first crystal forward o-light and the first crystal forward e-light to the first Faraday rotator 140. The first Faraday rotator 140 is configured to rotate the polarization states of the first crystal forward o-light and the first crystal forward e-light by an α angle (45°) in the first rotation direction and then output them to the second birefringent crystal 130. The second birefringent crystal 130 is configured to create a second forward relative displacement between the first crystal forward o-light and the first crystal forward e-light. The sum of the first forward relative displacement and the second forward relative displacement causes the first crystal forward o-light and the first crystal forward e-light to overlap as a single beam, which is then output as divergent beam to the lens 120. The lens 120 is configured to convert the divergent beam into convergent beam and output it to the single-core waveguide 110.

As shown in FIG. 18, when the backward light enters the single-core waveguide 110 in the backward direction of the light path, the single-core waveguide 110 is configured to output the backward light as divergent beam to the lens 120. The lens 120 is configured to convert the backward light into convergent beam and output it to the second birefringent crystal 130. The second birefringent crystal 130 is configured to create a second backward relative displacement between the two backward linearly polarized lights which are separated from the backward light and have perpendicular polarization states to each other, and then output them to the first Faraday rotator 140. The first Faraday rotator 140 is configured to rotate the polarization of the two backward linearly polarized lights by an angle α (45°) in the first rotation direction and then output them to the first birefringent crystal 150. The first birefringent crystal 150 is configured to create a first backward relative displacement between the two backward linearly polarized lights. In the optical path between the forward input surface of the first birefringent crystal 150 and the forward output surface of the second birefringent crystal 130, the polarization states of the two backward linearly polarized lights in the first birefringent crystal 150 rotate by 90° relative to the forward light, with the o-light and e-light undergoing a transformation. This causes the optical paths of the two backward linearly polarized lights in the first birefringent crystal 150 to deviate from the forward light path in the first birefringent crystal 150, and ultimately the two backward linearly polarized lights output from the first birefringent crystal 150 cannot be coupled into any core of the dual-core polarization-maintaining waveguide 160.

It can be understood that the structures of the optical parts and the optical principles utilized in the polarization beam combiner with isolation function 300 is same as those in the polarization beam splitter with isolation function 100 mentioned above. Detailed explanation of the specific principles will not be repeated here. The only difference is that the first rotation direction of the first Faraday rotator is reversed relative to that of the polarization beam splitter with isolation function, and then taking the backward light path of the splitter as the forward light path of the combiner can form the polarization beam combiner with isolation function 300. For the polarization beam combiner with isolation function 300, please directly refer to the specific examples provided below:

### Third Embodiment

In this embodiment, the forward light path of combiner is from right to left. However, the coordinate system used for the displacement analysis of this embodiment still adopts the xyz coordinate system of splitter (the forward direction of z-axis is from left to right) for ease of explanation, and adopting the same configuration of optical parts as the first embodiment of splitter. The first birefringent crystal 150 adopts the aforementioned birefringent crystal B220 provided in FIG. 6b, the second birefringent crystal 130 adopts the aforementioned birefringent crystal A210 provided in FIG. 6a, and the dual-core polarization-maintaining waveguide 160 still adopts the same dual-core spacing and polarization direction as in first embodiment, only the first rotation direction of the first Faraday rotator is rotated in the opposite direction, and then the backward isolation function of the splitter is converted into the forward combining function of the combiner. Along the forward light path, the polarization state of the first crystal forward o-light in the first birefringent crystal 150 and the second birefringent crystal 130 is o-e.

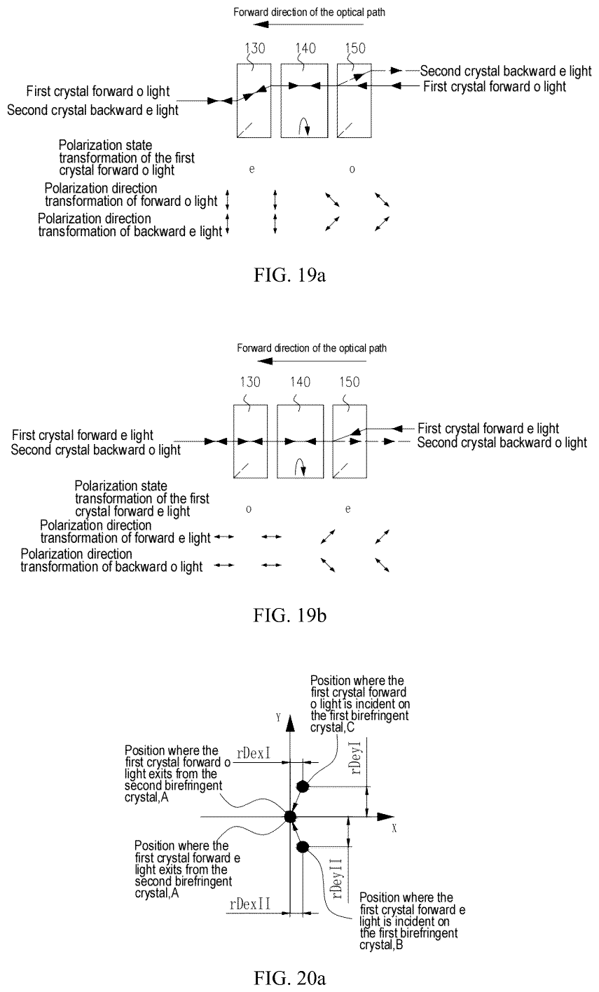

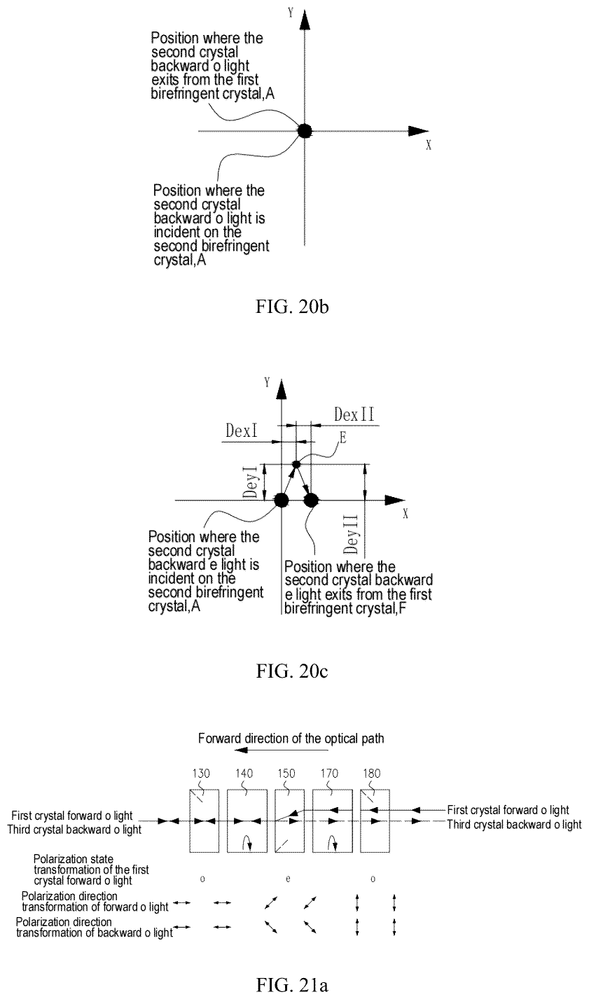

The optical path of the polarization beam combiner with isolation function provided in this embodiment is shown in FIGS. 19a and 19b. The displacements of the forward light and backward light in this embodiment are shown in FIGS. 20a to 20c. The specific principles are consistent with the related explanations in the above first embodiment and will not be further elaborated here. Ultimately, the exit points for both the first crystal forward o-light and the first crystal forward e-light are point A (0, 0), which can be coupled into the single-core waveguide. The exit point for the second crystal backward o-light is point A (0, 0), and the exit point for the second crystal backward e-light is point F (2 a, 0), neither of which can return to any core of the dual-core polarization-maintaining waveguide 160.

In other embodiments, the structure of the birefringent crystals and the arrangement of the optical paths are the same as in the aforementioned third embodiment, the difference is the rotation direction of the Faraday rotator is reversed and make the polarization state of the first crystal forward o-light in the first birefringent crystal 150 and the second birefringent crystal 130 are o-o, the polarization beam combining and the backward isolation function can be achieved by reasonably setting the dual-core spacing and the polarization direction of the dual-core polarization-maintaining waveguide 160. The polarization state changes and light displacements are same in principle, and will not be further elaborated here.

It should be noted that the above embodiment is provided as exemplary illustrations, and the deviation, deviation direction, deviation distance of the optical path will not be the limitation to present disclosure. Based on the structure proposed in this embodiment, all schemes that achieve forward beam combining and backward beam isolation by reasonably designing the structure, optical axis and the polarization state relationship of the o-light and e-light of the first birefringent crystal 150 and the second birefringent crystal 130 should be included within the scope of protection of present disclosure.

Furthermore, the coordinate system established in the polarization beam combiner with isolation function provided in this embodiment is the same as the coordinate system established in the polarization beam splitter with an isolation function 100 mentioned above. That is, the coordinate system is established with the backward light path of the combiner as the positive direction of z-axis. The requirements for the walk-off angles θ1 and θ2 of the first birefringent crystal 150 and the second birefringent crystal 130, as well as the angles φ1 and φ2 between the y-axis and the lines where the e-light oscillation planes through their optical axes intersect with the xy plane, are the same as the requirements for the splitter mentioned above, and will not be further elaborated here.

The polarization beam combiner with isolation function provided in this embodiment, like the splitter, has a simple structure, is easy to manufacture, and can reduce production costs.

The above provides a polarization beam combiner with a single-stage isolation. The polarization beam combiner can also achieve dual-stage isolation, the principle of which is the same as the polarization beam splitter with dual-stage isolation mentioned above. Specific examples will be provided in the following embodiments.

### Fourth Embodiment

In this embodiment, the forward light path of combiner is from right to left. However, the coordinate system used for the displacement analysis of this embodiment still adopts the xyz coordinate system of splitter (the forward direction of z-axis is from left to right) for ease of explanation, and adopting the same configuration of optical parts as the second embodiment of splitter. The first birefringent crystal 180 adopts the aforementioned birefringent crystal E250 provided in FIG. 12c, the second birefringent crystal 150 adopts the aforementioned birefringent crystal D240 provided in FIG. 12b, the third birefringent crystal 130 adopts the aforementioned birefringent crystal C230 provided in FIG. 12a, and the dual-core polarization-maintaining waveguide 160 still adopts the same dual-core spacing and polarization direction as in second embodiment, only the first rotation direction of the first Faraday rotator and the second rotation direction of the second Faraday rotator are rotated in the opposite direction comparing to that in the second embodiment, and then the backward isolation function of the splitter is converted into the forward combining function of the combiner. Along the forward light path, the polarization state of the first crystal forward o-light in the first birefringent crystal 180, the second birefringent crystal 150 and the third birefringent crystal 130 is o-e-o.

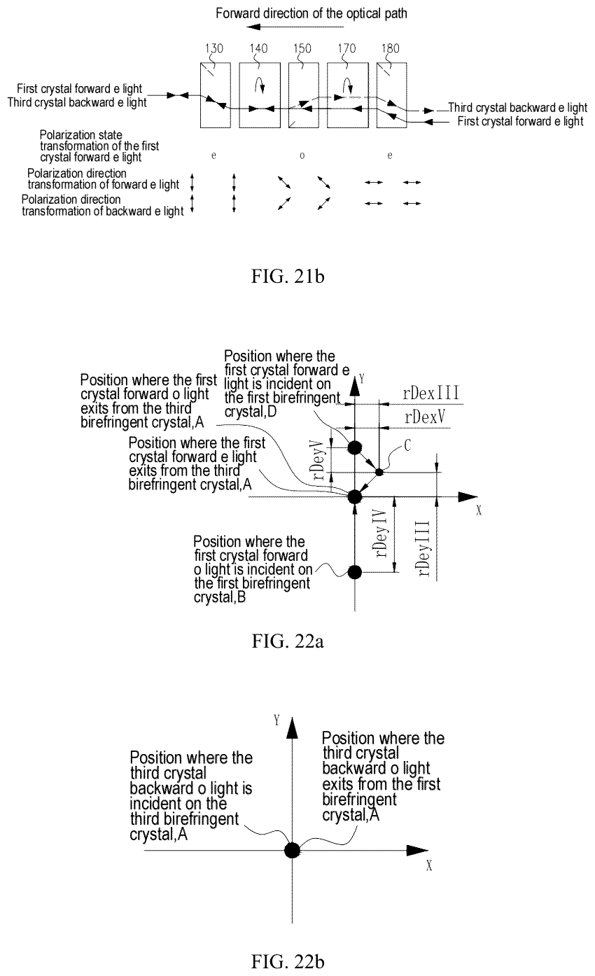

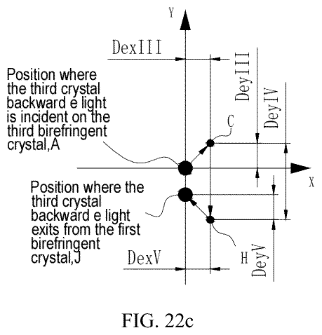

The optical path of the polarization beam combiner with dual-stage isolation function provided in this embodiment is shown in FIGS. 21a and 21b. The displacements of the forward light and backward light in this embodiment are shown in FIGS. 22a to 22c. The specific principles are consistent with the related explanations in the above first embodiment and will not be further elaborated here. Ultimately, the exit points for both the first crystal forward o-light and the first crystal forward e-light are point A (0, 0), which can be coupled into the single-core waveguide. The exit point for the third crystal backward o-light is point A (0, 0), and the exit point for the third crystal backward e-light is point J (0, −a), neither of which can return to any core of the dual-core polarization-maintaining waveguide 160.

In other embodiments, the structure of the birefringent crystals and the arrangement of the optical paths are the same as in the aforementioned fourth embodiment, the difference is the polarization state of the first crystal forward o-light in the first birefringent crystal 180, the second birefringent crystal 150 and the third birefringent crystal 130 are one of o-o-o, o-o-e, o-e-e. The polarization state changes and light displacements are same in principle, and will not be further elaborated here.

It should be noted that the above embodiment is provided as exemplary illustrations, and the deviation, deviation direction, deviation distance of the optical path will not be the limitation to present disclosure. Based on the structure proposed in this embodiment, all schemes that achieve forward beam combining and backward beam isolation by reasonably designing the structure, optical axis and the polarization state relationship of the o-light and e-light of the first birefringent crystal 180, the second birefringent crystal 150 and the third birefringent crystal 130 should be included within the scope of protection of present disclosure.

The polarization beam combiner with dual-stage isolation function 300 provided in this embodiment, the first birefringent crystal 180, the first Faraday rotator 170, the second birefringent crystal 150, the second Faraday rotator 140 and the third birefringent crystal 130 are all parallel plate structures and arranged successively. It is not only keeps the structural simplicity and ease of processing of the parts but also forms a dual-stage isolation for the backward light beam to achieve the enhanced isolation effect.

The first birefringent crystal 180, the second birefringent crystal 150 and the third birefringent crystal 130 in the polarization beam combiner with dual-stage isolation function 300 provided in this embodiment can also adopt combined crystals. For details, please refer to the aforementioned combiner's explanation regarding combined crystals, it will not be further elaborated here.

Finally, it should be stated that: the above embodiments are only used to illustrate the technical solutions of present disclosure and do not constitute the limitation to present disclosure; although the disclosure has been described in detail with reference to the aforementioned embodiments, those skilled in the art should understand that they can still modify the technical solutions recorded in the aforementioned embodiments or equivalently replace part or all of the technical features; such modifications or replacements do not deviate from the essence of the technical solutions of the embodiments of present disclosure. In particular, as long as there is no structural conflict, the technical features mentioned in each embodiment can be organized in any way.

What is claimed is:

1. A polarization beam splitter with isolation function, comprising: a single-core waveguide, a lens, a first birefringent crystal, a first Faraday rotator, a second birefringent crystal and a dual-core polarization-maintaining waveguide that are successively arranged along the forward optical path; the first birefringent crystal, the first Faraday rotator, and the second birefringent crystal are all parallel plate structures;
the single-core waveguide is configured to import divergent beam and output it to the lens;
the lens is configured to convert the divergent beam into convergent beam and output it to the first birefringent crystal;
the first birefringent crystal is configured to separate the convergent beam into the first crystal forward o-light and the first crystal forward e-light whose polarization directions are perpendicular to each other, and form a first forward relative displacement between the first crystal forward o-light and the first crystal forward e-light, and then output them to the first Faraday rotator;
the first Faraday rotator is configured to rotate the polarization direction of the first crystal forward o-light and the first crystal forward e-light by an angle of a in the first rotation direction and then output them to the second birefringent crystal, where α=45°;
the second birefringent crystal is configured to form a second forward relative displacement between the first crystal forward o-light and the first crystal forward e-light, and then output them to the two cores of the dual-core polarization-maintaining waveguide;
the distance between the two cores of the dual-core polarization-maintaining waveguide is equal to the sum of the first forward relative displacement and the second forward relative displacement between the first crystal forward o-light and the first crystal forward e-light, the polarization states of the two cores of the dual-core polarization-maintaining waveguide are aligned with the polarization states of the first crystal forward o-light and the first crystal forward e-light output from the second birefringent crystal; the dual-core polarization-maintaining waveguide is configured to export the first crystal forward o-light and the first crystal forward e-light;
when two backward linearly polarized lights that are aligned with the polarization states of the two cores of the dual-core polarization-maintaining waveguide respectively enter the two cores of the dual-core polarization-maintaining waveguide along the backward light path, the two cores of the dual-core polarization-maintaining waveguide are configured to output the two backward linearly polarized lights to the second birefringent crystal, and the polarization states of the two backward linearly polarized lights are aligned with the o-light and e-light polarization states of the second birefringent crystal;
the second birefringent crystal is configured to form a second backward relative displacement between the two backward linearly polarized lights and then output them to the first Faraday rotator;
the first Faraday rotator is configured to rotate the polarization states of the two backward linearly polarized lights by an angle α in the first rotation direction and then output them to the first birefringent crystal;
the first birefringent crystal is configured to form a first backward relative displacement between the two backward linearly polarized lights; in the optical path between the forward input surface of the first birefringent crystal and the forward output surface of the second birefringent crystal, the polarization states of the two backward linearly polarized lights form a 90° rotation relative to the forward light with the o-light and e-light undergoing conversion in the first birefringent crystal, causing the optical path of the two backward linearly polarized lights in the first birefringent crystal to deviate from the forward light path in the first birefringent crystal, and ultimately, the two backward linearly polarized lights output from the first birefringent crystal cannot be coupled into the single-core waveguide after passing through the lens.

2. The polarization beam splitter with isolation function according to claim 1, wherein the polarization state of the first crystal forward o-light along the forward light path aligns with the o-light or e-light polarization state of the second birefringent crystal after passing through the first Faraday rotator.

3. The polarization beam splitter with isolation function according to claim 1, wherein, the angle θ1 between the normal to the forward light incidence surface of the first birefringent crystal and the optical axis of the first birefringent crystal is the first walk-off angle, wherein −90°<θ1<0° or 0°<θ1<90°, the first walk-off angle is configured to control the first forward relative displacement and the first backward relative displacement; and/or,
The angle θ2 between the normal to the forward light incidence surface of the second birefringent crystal and the optical axis of the second birefringent crystal is the second walk-off angle, wherein −90°≤θ2<0° or 0°<θ2≤90°, the second walk-off angle is configured to control the second forward relative displacement and the second backward relative displacement, as well as the optical path difference between the o-light and e-light cumulated in both the first birefringent crystal and the second birefringent crystal.

4. The polarization beam splitter with isolation function according to claim 1, wherein, an xyz coordinate system is established with the forward direction of the optical path as the positive direction of z-axis;
the e-light oscillation plane through the optical axis of the first birefringent crystal intersects with the xy plane at the first line, and the angle between the first line and the y-axis is φ1;
the e-light oscillation plane through the optical axis of the second birefringent crystal intersects with the xy plane at the second line, and the angle between the second line and the y-axis is φ2;
wherein, |φ2−φ1|=(m·90°±α), and m=1 or 3.

5. The polarization beam splitter with isolation function according to claim 1, wherein, it includes a second Faraday rotator and a third birefringent crystal successively arranged along the forward light path between the second birefringent crystal and the dual-core polarization-maintaining waveguide, both the second Faraday rotator and the third birefringent crystal are parallel plate structures;
the angle θ2 between the normal to the forward light incidence surface of the second birefringent crystal and the optical axis of the second birefringent crystal is the second walk-off angle, wherein −90°<θ2<0° or 0°<θ2<90°, the second walk-off angle is configured to control the second forward relative displacement and the second backward relative displacement;
the angle θ3 between the normal to the forward light incidence surface of the third birefringent crystal and the optical axis of the third birefringent crystal is the third walk-off angle, wherein −90°≤θ3<0° or 0°<θ3≤90°, the third walk-off angle is configured to control the third forward relative displacement and the third backward relative displacement, as well as the optical path difference between the o-light and e-light cumulated among the first birefringent crystal, the second birefringent crystal and the third birefringent crystal;
an xyz coordinate system is established with the forward direction of the optical path as the positive direction of z-axis; the e-light oscillation plane through the optical axis of the second birefringent crystal intersects with the xy plane at the second line, and the angle between the second line and the y-axis is φ2; the e-light oscillation plane through the optical axis of the third birefringent crystal intersects with the xy plane at the third line, and the angle between the third line and the y-axis is φ3; wherein, |φ3−φ2|=(m·90°±β), m=1 or 3, β=45°;
the second birefringent crystal is configured to output the first crystal forward o-light and the first crystal forward e-light to the second Faraday rotator; the second Faraday rotator is configured to rotate the first crystal forward o-light and the first crystal forward e-light by the β angle in the second rotation direction, and then output to the third birefringent crystal; the third birefringent crystal is configured to form a third forward relative displacement between the first crystal forward o-light and the first crystal forward e-light, and then output to the two cores of the dual-core polarization-maintaining waveguide respectively; the polarization states of the two cores of the dual-core polarization-maintaining waveguide are respectively aligned with the polarization states of the first crystal forward o-light and the first crystal forward e-light output from the third birefringent crystal, and the distance between the two cores of the dual-core polarization-maintaining waveguide is equal to the sum of the first forward relative displacement, the second forward relative displacement and the third forward relative displacement between the first crystal forward o-light and the first crystal forward e-light;
when two backward linearly polarized lights enter the two cores of the dual-core polarization-maintaining waveguide respectively, the two cores of the waveguide are configured to output the two backward linearly polarized lights to the third birefringent crystal with the polarization states of the two backward linearly polarized lights aligned with the o-light and e-light polarization states of the third birefringent crystal respectively; the third birefringent crystal is configured to form a third backward relative displacement between the two backward linearly polarized lights, and then output them as the third crystal backward o-light and the third crystal backward e-light to the second Faraday rotator; the second Faraday rotator is configured to rotate the polarization states of the third crystal backward o-light and the third crystal backward e-light by β angle along the second rotation direction and then output them to the second birefringent crystal; the second birefringent crystal is configured to form a second backward relative displacement between the third crystal backward o-light and the third crystal backward e-light, and then output them to the first Faraday rotator; in the optical path between the forward input surface of the second birefringent crystal and the forward output surface of the third birefringent crystal, the polarization states of the third crystal backward o-light and the third crystal backward e-light in the second birefringent crystal form a 90° rotation relative to the forward light, with the o-light and e-light undergoing a transformation, causing the optical path of the third crystal backward o-light and the third crystal backward e-light in the second birefringent crystal to deviate from the forward light path in the second birefringent crystal; the first Faraday rotator is configured to rotate the polarization states of the third crystal backward o-light and the third crystal backward e-light by α angle along the first rotation direction and then output them to the first birefringent crystal; the first birefringent crystal is configured to form a first backward relative displacement between the third crystal backward o-light and the third crystal backward e-light; in the optical path between the forward input surface of the first birefringent crystal and the forward output surface of the second birefringent crystal, comparing the forward light and the backward light which have the same polarization state in the second birefringent crystal, the polarization state of the backward light forms a 90° rotation relative to the forward light after being rotated by the first Faraday rotator by α angle along the first rotation direction, the o-light and e-light undergo a transformation in the first birefringent crystal which causes the optical path of the third crystal backward o-light and the third crystal backward e-light to deviate from the forward light path in the first birefringent crystal again; the sum of the third backward relative displacement, the second backward relative displacement and the first backward relative displacement ultimately causes the third crystal backward o-light and the third crystal backward e-light output from the first birefringent crystal to deviate from the forward light path, and they cannot be coupled into the single-core waveguide after passing through the lens.

6. The polarization beam splitter with isolation function according to claim 5, wherein, the polarization state of the first crystal forward o-light is aligned with the o-light or e-light polarization state of the third birefringent crystal after passing through the second Faraday rotator.

7. The polarization beam splitter with isolation function according to claim 5, wherein, the first birefringent crystal, and/or the second birefringent crystal, and/or the third birefringent crystal is a combined crystal, which can be configured to achieve the same relative displacement and also compensate for the optical path difference.

8. A polarization beam combiner with isolation function, comprising: a dual-core polarization-maintaining waveguide, a first birefringent crystal, a first Faraday rotator, a second birefringent crystal, a lens, and a single-core waveguide along the forward light path successively; the first birefringent crystal, the first Faraday rotator and the second birefringent crystal are parallel plate structures;
the two cores of the dual-core polarization-maintaining waveguide are configured to import two linearly polarized lights which polarization states are aligned with the polarization states of the two cores, and outputting them to the first birefringent crystal;
the o-light and e-light polarization states of the first crystal are aligned with the polarization states of the two linearly polarized lights, and the first birefringent crystal is configured to form a first forward relative displacement between the two linearly polarized lights and then output them to the first Faraday rotator as the first crystal forward o-light and the first crystal forward e-light;
the first Faraday rotator is configured to rotate the polarization states of the first crystal forward o-light and the first crystal forward e-light by α angle in the first rotation direction and then output them to the second birefringent crystal, wherein α=45°;
the second birefringent crystal is configured to form a second forward relative displacement between the first crystal forward o-light and the first crystal forward e-light, the sum of the first forward relative displacement and the second forward relative displacement causes the first crystal forward o-light and the first crystal forward e-light to coincide as a single beam of light and then output to the lens as divergent beam;
the lens is configured to convert the divergent beam into convergent beam and output it to the single-core waveguide;
when the backward light enters the single-core waveguide in the backward light path, the single-core waveguide is configured to output the backward light to the lens as divergent beam;
the lens is configured to convert the backward light into convergent beam and output it to the second birefringent crystal;
the second birefringent crystal is configured to form a second backward relative displacement between the two backward linearly polarized lights which are separated from the backward light and are in perpendicular polarization state to each other, and then output them to the first Faraday rotator;
the first Faraday rotator is configured to rotate the polarization states of the two backward linearly polarized lights by α angle in the first rotation direction and then output them to the first birefringent crystal;
the first birefringent crystal is configured to form a first backward relative displacement between the two backward linearly polarized lights; in the optical path between the forward input surface of the first birefringent crystal and the forward output surface of the second birefringent crystal, the polarization states of the two backward linearly polarized lights form a 90° rotation relative to the forward light with the o-light and e-light undergoing transformation in the first birefringent crystal, causing the optical path of the two backward linearly polarized lights to deviate from the forward light path in the first birefringent crystal, and ultimately, the two backward linearly polarized lights output from the first birefringent crystal cannot be coupled into any core of the dual-core polarization-maintaining waveguide.

9. The polarization beam combiner with isolation function according to claim 8, wherein, the polarization state of the first crystal forward o-light along the forward light path, aligns with the o-light or e-light polarization state of the second birefringent crystal after passing through the first Faraday rotator.

10. The polarization beam combiner with isolation function according to claim 8, wherein, the angle θ1 between the normal to the forward light incidence surface of the first birefringent crystal and the optical axis of the first birefringent crystal is the first walk-off angle, wherein −90°<θ1<0° or 0°<θ1<90°, the first walk-off angle is configured to control the first forward relative displacement and the first backward relative displacement; and/or, the angle θ2 between the normal to the forward light incidence surface of the second birefringent crystal and the optical axis of the second birefringent crystal is the second walk-off angle, wherein −90°≤θ2<0° or 0°<θ2≤90°, the second walk-off angle is configured to control the second forward relative displacement and the second backward relative displacement, as well as the optical path difference between the o-light and e-light cumulated in both the first birefringent crystal and second birefringent crystal.

11. The polarization beam combiner with isolation function according to claim 8, an xyz coordinate system is established with the backward light path as the positive direction of z-axis;
the e-light oscillation plane through the optical axis of the first birefringent crystal intersects with the xy plane at the first line, the angle between the first line and the y-axis is φ1;
the e-light oscillation plane through the optical axis of the second birefringent crystal intersects with the xy plane at the second line, the angle between the second line and the y-axis is φ2; wherein, |φ2−φ1|=(m·90°±α), and m=1 or 3.

12. The polarization beam combiner with isolation function according to claim 8, wherein the polarization beam combiner with isolation function further comprises: a second Faraday rotator and a third birefringent crystal arranged along the forward light path successively and between the second birefringent crystal and the lens; both the second Faraday rotator and the third birefringent crystal are parallel plate structures;
the angle θ2 between the normal to the forward light incidence surface of the second birefringent crystal and the optical axis of the second birefringent crystal is the second walk-off angle, wherein −90°<θ1<0° or 0°<θ1<90°, and the second walk-off angle is configured to control the second forward relative displacement and the second backward relative displacement; the angle θ3 between the normal to the forward light incidence surface of the third birefringent crystal and the optical axis of the third birefringent crystal is the third walk-off angle, wherein −90°≤θ3<0° or 0°<θ3≤90°, and the third walk-off angle is configured to control the third forward relative displacement and the third backward relative displacement, as well as the optical path difference between the o-light and e-light cumulated among the first birefringent crystal, the second birefringent crystal and the third birefringent crystal;
an xyz coordinate system is established with the backward direction of the light path as the positive direction of z-axis, the e-light oscillation plane through the optical axis of the second birefringent crystal intersects the xy plane at the second line, and the angle between the second line and the y-axis is φ2; the e-light oscillation plane through the optical axis of the third birefringent crystal intersects the xy plane at the third line, and the angle between the third line and the y-axis is φ3, wherein |φ3−φ2|=(m·90°±β), m=1 or 3, β=45°;
the second birefringent crystal is configured to form a second forward relative displacement between the first crystal forward o-light and the first crystal forward e-light, and then output the first crystal forward o-light and the first crystal forward e-light to the second Faraday rotator; the second Faraday rotator is configured to rotate the polarization state of the first crystal forward o-light and the first crystal forward e-light by the β angle in the second rotation direction, and then output to the third birefringent crystal; the third birefringent crystal is configured to form a third forward relative displacement between the first crystal forward o-light and the first crystal forward e-light, the sum of the first forward relative displacement, the second forward relative displacement and the third forward relative displacement causes the first crystal forward o-light and the first crystal forward e-light to overlap into a single beam of light, and outputs it as a divergent beam to the lens; the lens is configured to convert the divergent beam into convergent beam and output it to the single-core waveguide;
when the backward light enters the single-core waveguide in the backward light path, the single-core waveguide is configured to output the backward light to the lens as a divergent beam; the lens is configured to convert the backward divergent light into convergent beam and output it to the third birefringent crystal; the third birefringent crystal is configured to separate the backward light into the third crystal backward o-light and the third crystal backward e-light with mutually perpendicular polarization states, and then output them to the second Faraday rotator, the third backward relative displacement between the third crystal backward o-light and the third crystal backward e-light is formed; the second Faraday rotator is configured to rotate the polarization states of the third crystal backward o-light and the third crystal backward e-light by β angle along the second rotation direction and then output them to the second birefringent crystal; the second birefringent crystal is configured to form a second backward relative displacement between the third crystal backward o-light and the third crystal backward e-light, and then output them to the first Faraday rotator; in the optical path between the forward input surface of the second birefringent crystal and the forward output surface of the third birefringent crystal, the polarization states of the third crystal backward o-light and the third crystal backward e-light form a 90° rotation relative to the forward light with the o-light and e-light undergoing a transformation in the second birefringent crystal, causing the optical path of the third crystal backward o-light and the third crystal backward e-light to deviate from the forward light path in the second birefringent crystal; the first Faraday rotator is configured to rotate the polarization states of the third crystal backward o-light and the third crystal backward e-light by α angle along the first rotation direction and then output them to the first birefringent crystal; the first birefringent crystal is configured to form a first backward relative displacement between the third crystal backward o-light and the third crystal backward e-light; in the optical path between the forward input surface of the first birefringent crystal and the forward output surface of the second birefringent crystal, comparing the forward light and the backward light which have the same polarization state in the second birefringent crystal, the polarization state of the backward light forms a 90° rotation relative to the forward light after being rotated by the first Faraday rotator by α angle along the first rotation direction, the o-light and e-light undergo a transformation in the first birefringent crystal which causes the optical path of the third crystal backward o-light and the third crystal backward e-light to deviate from the forward light path in the first birefringent crystal again; the sum of the third backward relative displacement, the second backward relative displacement and the first backward relative displacement ultimately causes the third crystal backward o-light and the third crystal backward e-light output from the first birefringent crystal to deviate from the forward light path, and they cannot be coupled into any core of the dual-core polarization-maintaining waveguide.

13. The polarization beam combiner with isolation function according to claim 12, wherein, the polarization state of the first crystal forward o-light along the forward light path aligns with the o-light or e-light polarization state of the third birefringent crystal after passing through the second Faraday rotator.

14. The polarization beam combiner with isolation function according to claim 12, wherein, the first birefringent crystal, and/or the second birefringent crystal, and/or the third birefringent crystal is a combined crystal, which can be configured to achieve the same relative displacement and also compensate for the optical path difference.
